(19) United States
(12) Patent Application Publication
(10) Pub. No.: US 2023/0081814 A1
(43) Pub. Date: Mar. 16, 2023

(54) Sheet Metal Packaging Product with Textured Surface And Method of Producing Such a Sheet Metal Packaging Product

(71) Applicant: ThyssenKrupp Rasselstein GmbH, Andernach (DE)

(72) Inventors: Folkert SCHULZE-KRAASCH, Duisburg (DE); Karl-Heinz KOPPLIN, Essen (DE); Stefan WISCHMANN, Berlin (DE); Martin KOCH, Neukirchen-Vluyn (DE); Jörg GORSCHLÜTER, Dortmund (DE); Manuel KÖHL, Mendig (DE); Patrick THIEL, Gierschnach (DE); Walter HÖRNIG, Neustadt (DE); Frank SCHUMANN, Neuwied (DE); Markus OPPER, Neuwied (DE)

(73) Assignee: ThyssenKrupp Rasselstein GmbH, Andernach (DE)

(21) Appl. No.: 17/796,296

(22) PCT Filed: Jan. 12, 2021
(86) PCT No.: PCT/EP2021/050447

§ 371 Date: Jul. 29, 2022

(30) Foreign Application Priority Data
Jan. 31, 2020 (DE) 10 2020 102 381.2

(51) Int. Cl. C25D 5/00; C21D 9/48; C21D 8/02; C21D 10/00; B32B 15/01; C21D 6/00; C25D 5/10; C25D 5/50; C25D 7/06; C25D 5/36; C25D 9/10; C22C 38/16; C22C 38/14; C22C 38/08; C22C 38/12; C22C 38/06; C22C 38/04; C22C 38/02; C22C 38/00; B21B 1/22; B21B 27/00

(52) U.S. Cl. CPC C25D 5/627; C21D 9/48; C21D 8/0205; C21D 8/0226; C21D 8/0273; C21D 10/00; B32B 15/013; C21D 6/005; C21D 6/008; C21D 6/001; C25D 5/605; C25D 5/10; C25D 5/505; C25D 7/0614; C25D 5/36; C25D 9/10; C22C 38/16; C22C 38/14; C22C 38/08; C22C 38/12; C22C 38/06; C22C 38/04; C22C 38/02; C22C 38/008; C22C 38/002; C22C 38/001; B21B 1/227; B21B 27/005

(57) ABSTRACT

The invention relates to sheet metal packaging products, in particular tinplate or electrolytically chrome-plated sheet steel (ECCS), consisting of a sheet steel substrate (S) with a thickness in the region of 0.1 mm to 0.6 mm and a coating (B), in particular made of tin and/or chromium or chromium and chromium oxide, that is electrolytically deposited on at least one side of the sheet metal substrate. In addition, at least one surface of the sheet metal packaging product provided with the coating (B) has a surface profile with periodically repeating structure elements in at least one direction, wherein an autocorrelation function resulting from the surface profile has a plurality of side lobes with a height of at least 20%, preferably at least 30% of the height of the main lobe. These sheet metal packaging products have improved and novel surface properties.

### FIELD OF THE INVENTION

The invention relates to a sheet packaging product, as well as a method for manufacturing a sheet packaging product.

### BACKGROUND

Cold-rolled sheet packaging products in the form of electrolytically tin-plated and chromium-coated steels are standardized in DIN EN 10 202 (European Standard EN 10 202: 2001). Packaging sheet products according to this standard are understood to be single cold-rolled or double-reduced mild steels that are either electrolytically tin-plated (tinplate) or electrolytically chromium-coated steels (ECCS). Single cold-rolled sheet packaging products are available in nominal thicknesses of 0.1 mm to approx. 0.6 mm, in particular 0.17 mm to 0.49 mm, and double-reduced sheet packaging products are supplied in nominal thicknesses of 0.13 mm to 0.29 mm. The sheet packaging products can be in the form of strips (which are wound into coils) or in the form of sheets. The strips have nominal widths of at least 600 mm, although slit strips can also have a smaller slit width.

According to the standard, electrolytically tin-plated tinplate is understood to be a cold-rolled sheet or strip of unalloyed steel with a low carbon content, coated on both sides with tin applied in a continuous electrolytic process. In addition, electrolytically differential tinplate is also available, in which one side (e.g. the top side) has a larger tin coating than the other side (e.g. the bottom side).

In order to achieve high corrosion resistance and a shiny surface, it is common practice for tinplate to heat the electrolytically deposited tin layer to a temperature above the melting point of tin after tinning the steel sheet substrate and then to cool it down. This temperature treatment produces a coating on the steel sheet substrate, which is composed of an iron-tin alloy on the surface of the steel sheet substrate and a layer of free tin near the surface. This top layer of free tin gives the fused tinplate a high gloss value. To increase the gloss of the tinplate surface, ground and polished skin pass rolls can be used in accordance with the standard, with which the tin surface of the tinplate is re-rolled or skin-passed in a secondary rolling operation (skin-passing), the degree of reduction of the secondary rolling operation during skin-passing preferably being less than or equal to 5% (bright skin-passing).

Furthermore, so-called “stone-finish/fine-stone-finish” surfaces are known from the standard, which are characterized by a directional surface structure that results from the use of ground skin-pass rolls, which have a pronounced grinding structure and a higher roughness than the skin-pass rolls used for a glossy surface. Furthermore, a “blasted surface” can be achieved when using blasted skin pass rolls. When using blasted skin pass rolls, either a silver matte surface can be produced on tinplate if the tin layer is fused, or a matte surface if the tin layer is not fused. In addition, skin pass rolls are also used which are textured by means of EDT (“electro discharge texturing”).

Electrolytic Chromium Coated Steel (ECCS) is defined by the standard as cold-rolled, electrolytically treated mild steel sheet or strip with a low carbon content, having a layer of metallic chromium directly on the steel sheet substrate and a top layer of hydrated chromium oxide or chromium hydroxide on the metallic chromium layer.

For the surface finish of sheet packaging products, the standard specifies nominal surface roughnesses of the sheet steel substrate by means of defined arithmetic center roughnesses (Ra), which are, for example, Ra≤0.35 μm for tinplate with a glossy surface and Ra≥0.90 μm for a silver-matte tinplate surface. In the case of electrolytically specially Chromium Coated Steel Sheet (ECCS), the surface roughnesses required by the standard are in the range from 0.25 μm to 0.45 μm for a “fine-stone” surface and from 0.35 μm to 0.60 μm for a “stone” surface.

Recently, the packaging industry has been placing increasingly high demands on the optical properties of the surfaces of sheet packaging products, such as their gloss, reflection and brightness, as well as on corrosion resistance and mechanical properties, such as resistance to abrasion, which cannot be met by the standard sheet packaging products available and known from the state of the art. The surface properties of known packaging sheet products are normally influenced by the surface topography, which is set in tinplate production, for example, during re-rolling (skin-passing). The production steps commonly used for this purpose, in which ground, blasted or eroded skin-pass rolls are used, for example, during re-rolling (secondary cold rolling or skin-passing), do not achieve the required surface properties, or only to a limited extent, because the structures of the work rolls (skin-pass rolls) used during re-rolling are sometimes too inhomogeneous and sometimes too highly directional. Due to the inhomogeneous surface structure of the work rolls, it is not possible, for example, to achieve a homogeneous surface with a directional gloss effect.

Increasingly higher demands are also being placed on the material in terms of corrosion resistance and the processability of sheet packaging products in the manufacture of packaging containers, such as tin cans and beverage cans. In order to improve the corrosion resistance of sheet packaging products, higher weights of the tin layer or the chromium/chrome oxide layer could be produced. However, this is ruled out from the point of view of resource efficiency, because higher quantities of the coating materials (such as tin and chromium) are required for this. In this respect, there is a need to improve the corrosion resistance of sheet packaging products without increasing the weight of the electrodeposited coating.

Increasingly stringent requirements are also being placed on the processability of sheet packaging products in forming processes, such as deep-drawing and Drawing and Wall Ironing processes, in which packaging containers or parts thereof are formed from the sheet packaging product. A major problem in the processing of tinplate packaging products in the form of coiled tinplate strips is based on the abrasion of particles from the electrolytically deposited tin coating. After electrolytic coating of the steel sheet substrate, which is regularly carried out in coil coating lines, the strip-shaped tinplate packaging products are wound onto a coil and transported to forming lines for further processing to produce packaging, where they are unwound from the coil and cut into sheets. In this processing step, rollers that come into contact with the surface of the coated strip are used to guide and deflect the strip. In this process, and also in the further processing steps when the packaging sheet is formed using forming tools, particles of the coating materials (such as tin) can become detached from the coating. This results in harmful abrasion, which can occur in particular during winding and unwinding of the strip to form a coil, as well as during cutting of the roll into sheets and also during forming in drawing and forming tools. The abrasive material, which consists at least essentially of the material of the metallic coating (i.e., for example, tin in the case of tinplate), can cause the strip as well as the guide and deflection rollers and/or the forming tools to become re-contaminated. Furthermore, the abrasion of particles of the coating materials can adhere to the surface of the packaging containers produced from the sheet packaging products in forming processes and contaminate the inserted contents when the packaging containers are filled with a product. To prevent this, the guide and deflection rollers used for winding and unwinding the strips and the drawing and forming tools used for the forming processes are cleaned regularly. This is time-consuming and costly and reduces the efficiency of the manufacturing processes for the sheet packaging products and the packaging containers made from them.

### SUMMARY

On this starting point, the invention is based on the following tasks: On the one hand, the higher demands on the surface properties of the sheet packaging products, such as optimized and specifically adjustable gloss, reflection and brightness properties, are to be met. On the other hand, the corrosion resistance of the sheet packaging products is also to be improved while maintaining the weight of the electrolytically deposited coating, as is the processability of the sheet packaging products during transport and during the manufacture of packaging by means of forming processes.

These tasks are addressed by the sheet packaging product disclosed herein. Preferred embodiments and aspects as well as advantageous properties and features of the sheet packaging products according to the invention are also disclosed herein. The inventive method for producing sheet packaging products disclosed herein further contributes to addressing the above-identified issues.

The sheet packaging product according to the invention is in particular in the form of an electrolytically tin-plated steel sheet (tinplate) or in the form of an electrolytically chromium-coated steel sheet (ECCS) and consists of a steel sheet substrate having a thickness in the range from 0.1 mm to 0.6 mm and a coating of tin (in the case of tinplate) or of chromium/chromium oxide (in the case of ECCS) electrolytically deposited on at least one surface, preferably on both surfaces, of the steel sheet substrate and, according to the invention, has a surface structure with a plurality of uniform, i.e. homogeneous, chromium oxide layers over the surface of the steel sheet substrate, i.e. homogeneously, distributed over the surface of the sheet packaging product and having periodically recurring structural elements.

The coating of the sheet packaging product, which is electrolytically deposited on at least one side of the sheet steel substrate, consists of tin and/or of chromium or chromium and chromium oxide, the coating comprising a tin layer with a coating weight in the range from 1 to 15 g/m² tin and/or a layer of chromium and/or chromium oxide with a total coating weight of chromium in the chromium/chromium oxide layer in the range from 5 to 200 mg/m². The sheet packaging product according to the invention is characterized in that at least one surface of the sheet packaging product provided with the coating has in at least one direction a surface profile with periodically recurring structural elements and has an autocorrelation function resulting from the surface profile with an absolute maximum and a plurality of secondary maxima, the height of which is at least 20%, preferably at least 30%, of the height of the absolute maximum.

Optionally, further coatings or overlays can be applied to the electrolytic coating. In the case of tinplate, for example, a passivation layer of chromium and/or chromium oxide or a chromium-free material can be applied, and polymer layers of thermoplastics can be applied to the chromium/chromium oxide coating of ECCS. A tin coating can be fused by heating the tin-plated sheet steel substrate to temperatures above the melting point of tin.

The periodically recurring structural elements on the surface of the sheet packaging product according to the invention can have different shapes and, in particular, be formed as concave or plateau-shaped flattened elevations. Periodically recurring depressions may also be provided, which are surrounded by elevations.

The periodically recurring structures are first produced in a manufacturing process by secondary cold rolling of an already primarily cold-rolled steel sheet substrate, in particular in a re-rolling step with a degree of re-rolling in the range from 5% to 50% or skin-passing with a degree of re-rolling of less than 5%, in particular in the range from 1% to 4%, into the surface of the steel sheet substrate by means of at least one surface-structured roll, and the steel sheet substrate surface-structured in this way is then refined by electrolytic deposition of the coating.

The method according to the invention for producing a sheet packaging product with a structured surface, thereby comprises the following steps:
Providing a primary cold-rolled steel sheet substrate (S) with a thickness in the range of 0.1 mm to 0.6 mm;
Recrystallizing annealing of the primary cold-rolled steel sheet substrate (S);
Re-rolling or skin-passing the recrystallization-annealed steel sheet substrate (S) in a two-stand re-rolling mill, a first stand of the re-rolling mill having at least one working roll with an unstructured roll surface, in particular with a blasted or polished roll surface, and a second stand of the re-rolling mill having at least one working roll with a surface-structured roll surface;
Electrolytic coating of the re-rolled or skin-passed steel sheet substrate (S) on at least one side with a coating (B) of tin and/or of chromium or chromium and chromium oxide, the coating (B) comprising a tin layer with a coating weight in the range from 1 to 15 g/m² tin and/or a layer of chromium or chromium oxide with a total coating weight of chromium in the chromium or chromium oxide layer in the range from 5 to 200 mg/m²;
wherein a surface profile with periodically recurring structural elements in at least one direction is produced at the surface of the steel sheet electrolytically coated with the coating (B) and the surface structure has an autocorrelation function which has an absolute maximum and a plurality of secondary maxima whose height is at least 20% and preferably at least 30% of the height of the absolute maximum.

In the process according to the invention, the re-rolling or skin-passing of the recrystallizing annealed steel sheet substrate is carried out in a two-stand re-rolling mill comprising a first stand with at least one work roll having an unstructured roll surface, in particular a blasted or polished roll surface, and a second stand with at least one work roll having a (deterministically) surface-structured roll surface. The roll surface of the or each work roll of the first stand is thereby unstructured in the sense that the roll surface has a statistically uncorrelated structure without periodically recurring patterns. This applies, for example, to smooth, polished or blasted surfaces of work rolls or to roll surfaces that have been treated with a shot-blast texturing process (SBT) or an electro discharge texturing process (“EDT”) or an electron beam texturing process (“EDT”). In contrast, the roll surface of the or each work roll of the second stand is textured in the sense that the roll surface has a correlated, deterministic structure with periodically recurring structural elements. This applies, for example, to surfaces of work rolls that have been specifically structured with a pulsed laser, in particular with an ultrashort pulse laser, in order to produce a deterministic surface structure with periodically recurring structural elements. The autocorrelation function of the surface profile of such work rolls with a (deterministically) surface-structured roll surface exhibits in at least one direction, in particular in the circumferential direction and/or perpendicular thereto, an absolute maximum and a plurality of secondary maxima whose height is at least 60%, preferably at least 70% of the height of the absolute maximum.

Re-rolling of the recrystallizing annealed steel sheet substrate is usually carried out wet using cooling agents and lubricants, whereas skin pass molding is usually carried out dry or using special wet skin pass molding agents.

Preferably, two quattro stands arranged one behind the other in the direction of strip travel of the sheet steel substrate are used for temper rolling or skin pass rolling, each stand preferably having an upper and a lower work roll between which the recrystallizing annealed sheet steel substrate is passed. The two work rolls are arranged perpendicular to the strip running direction between two larger back-up rolls (an upper and a lower back-up roll), the surface of one back-up roll being in contact in each case with the roll surface of the associated work roll in order to stabilize the work roll. However, other roll stands, for example with six rolls, can also be used.

The roll surface of the two work rolls of the first and second stand is designed to be identical. However, it is also possible to use two work rolls with differently structured roll surfaces, particularly in the second stand. This allows a different surface structure to be imprinted on the bottom side of the sheet steel substrate than on the top side.

The or each surface-structured roll of the second stand can in particular be a work roll (skin pass roll) textured by a pulse laser, in particular a short-pulse laser or an ultrashort-pulse laser, in a texturing process, with which the steel sheet substrate is re-rolled in a secondary cold rolling step or skin passed in a skin pass step. During re-rolling or skin-passing, the surface structure of the work roll is impressed into the surface of the steel sheet substrate.

The sequence of the two roll stands (i.e. the first and the second stand) in the direction of strip travel of the steel sheet substrate is arbitrary, i.e. the first stand with the unstructured roll surface can be re-rolled or skin-passed first and then the second stand with the structured roll surface, or vice versa. A more uniform and cleaner surface structure is achieved if the first stand with the unstructured roll surface is re-rolled or skin-passed first and then the second stand with the structured roll surface, which is why this variant is preferred. In this case, the first stand is used to reduce the thickness of the steel sheet substrate passing through the opposing work rolls (which is up to 5% during skin pass and between 5 and 50% during rerolling).

During skin-pass rolling (with re-rolling pass rates of less than 5%, in particular 1 to 4%), the steel sheet substrate, which has already been cold-rolled in the first cold-rolling step (primary cold rolling) and thereby is considerably (regularly more than 85%) reduced in thickness, is pre-structured in the first stand with the unstructured work rolls. This pre-structuring of the surface, which is strongly and unevenly influenced during primary cold rolling, enables the introduction of a better structured, deterministic surface structure in the subsequent second stand with the work rolls arranged therein with a structured, uniform surface with periodically arranged structural elements.

During re-rolling (with re-rolling degrees of more than 5%, in particular from 10 to 50%), on the one hand a further thickness reduction takes place to achieve the desired final thickness of preferably less than 0.5 mm, together with an associated work hardening. In addition, the sheet steel substrate, which has already been cold-rolled in the first cold rolling step (primary cold rolling) and thereby significantly (regularly more than 80%) reduced in thickness, is pre-structured in the first stand with the unstructured work rolls. This pre-structuring of the surface of the primarily cold-rolled steel sheet in the first stand is necessary during the re-rolling process in order to be able to introduce a structured, deterministic surface structure at all. For this purpose, after re-rolling in the first stand, the steel sheet re-rolled to the desired final thickness is provided in the subsequent second stand with the work rolls arranged therein with a structured, uniform surface texture with periodically arranged structural elements.

With the re-rolling or skin-passing process described, steel sheet substrates can be produced which have a surface profile with structures recurring periodically along selected directions (in particular in the rolling direction or perpendicular to the rolling direction), wherein the periodicity and the uniformity of the surface structures can be quantified by means of an autocorrelation function and the height of a plurality of secondary maxima of the autocorrelation function of a surface profile along at least one preferred direction is at least 40% and preferably at least 60% of the height of the main maximum (or the absolute maximum).

Deviations in the regularity of surface structures can be identified by means of the autocorrelation function

$${Ψ}_{zz} ( x ) = \frac{1}{l} {\int }_{0}^{l} z ( {x}^{′} ) \cdot z ( {x}^{′} + x ) {dx}^{′}$$

$$with z ( x ) = 0 ; x ∉ [ 0 , l ]$$

quantifiable. The autocorrelation function is used here to assess the periodicity of the surface profile z(x) and specifically the surface roughness along given directions (x) in the plane of the surface.

It has been shown that the desired properties of the textured surface of the coated packaging sheet products, which can be characterized by an autorrelation function whose secondary maxima have at least 30% of the height of the absolute maximum, can only be achieved, at least for the double cold-rolled (DR) steel sheet substrates, with a two-stand mode of operation during skin pass or rerolling. In order to be able to produce coated packaging sheets (i.e. tinplate or ECCS) with an autorrelation function whose minor maxima are at least 30% of the height of the absolute maximum, it is necessary to generate a surface structure in the sheet steel substrate with an autorrelation function whose minor maxima are at least 40% of the height of the absolute maximum, since the periodically recurring structural elements are leveled to a certain extent during electrolytic coating of the structured surface of the substrate.

It is therefore also an aspect of the invention to provide, as an intermediate product of the process according to the invention, a cold-rolled steel sheet having a thickness in the range from 0.05 mm to 0.6 mm, the surface of which sheet has in at least one direction a surface profile with periodically recurring structural elements, an autocorrelation function resulting from the surface profile having a plurality of secondary maxima, the height of which is at least 40% of the height of the main maximum. Preferably, the secondary maxima of the autocorrelation function along a preferred direction have a height of at least 50% of the height of the main maximum and particularly preferably at least 60% of the height of the main maximum.

During the electrolytic deposition of the coating on the surface-structured steel sheet substrate, the coated steel sheet at least substantially retains the previously introduced surface structuring, since during the electrolytic deposition of the coating the coating material (tin in the case of tinplate or chromium/chromium oxide in the case of ECCS) is deposited uniformly, i.e. with an at least largely homogeneous overlay, on the structured surface of the steel sheet substrate close to the contour. Corresponding to the surface structuring of the sheet steel substrate, the sheet packaging product produced in this way, like the substrate, has a surface profile with a plurality of structures distributed uniformly over the surface and recurring periodically in at least one direction. This gives the sheet packaging product according to the invention a deterministic surface structure with a surface that has a defined and reproducible topography, which differs in particular from a topography with a statistical distribution of surface structures such as elevations, depressions and sharp peaks.

The sheet packaging products according to the invention consequently have on their surface in at least one (selected) direction a surface profile with periodically recurring structures, wherein an autocorrelation function with a plurality of secondary maxima results from the surface profile and the height of the secondary maxima is according to the invention at least 20%, preferably at least 30% of the height of the main maximum.

A tin coating applied electrolytically to the re-rolled or skin-passed steel sheet substrate can, if necessary, be additionally melted, whereby the surface structures are further leveled during the melting of the coating and the height of the secondary maxima of the autorrelation function is reduced as a result. Preferably, the tinplate with melted tin coating still has an autorrelation function whose secondary maxima are at least 20% of the height of the absolute maximum.

It was found that the surface structure of the sheet steel substrate can be at least largely retained if the steel substrate is electrolytically coated with a metallic coating, in particular a tin coating or a coating of chromium and chromium oxide. It is true that the electrolytic coating slightly smoothes the regular surface profile of the steel sheet substrate. Nevertheless, even after the electrolytic coating, the surface profile of the coated sheet packaging product with the periodically recurring structures remains surprisingly and clearly recognizably present at the minimum heights of a plurality of secondary maxima in the autorrelation function of more than 20% (in the case of molten tin coatings), preferably of more than 30%.

By selectively choosing and adjusting the surface topology, the packaging sheet products according to the invention can be used to selectively adjust the surface-sensitive properties, such as corrosion resistance, gloss and abrasion, and adapt them to different applications. For example, the optical surface properties of the sheet packaging product, such as gloss, reflection and brightness, can be influenced and adapted to desired properties and applications by selecting and adjusting the surface structure. Furthermore, by selecting and adjusting a suitable surface structure, the corrosion resistance of the sheet packaging product can be improved and abrasion during transport and further processing of the sheet packaging product can be minimized.

For example, the invention makes it possible to improve the corrosion resistance of the sheet packaging product without having to increase the weight of the coating by deterministically structuring the surface of the sheet packaging product with convex or plateau-shaped elevations that recur periodically on the surface. Due to this formation of the surface structure, the surface of the packaging sheet product in this embodiment of the invention, in contrast to conventional packaging sheet products with a statistically distributed surface structure, does not have any sharp peaks which can break off when the packaging sheets are subjected to mechanical stress or at which damage to the coating can occur. The packaging sheet products according to the invention can therefore be better processed even without compromising corrosion resistance, as they are more resistant to mechanical stresses.

Depending on the application and optimization case, the surface roughness (in particular the arithmetic mean roughness Ra) is in the range from 0.01 to 2.0 μm, preferably in the range from 0.1 to 1.0 μm and in particular in the range from 0.1 to 0.3 μm. The low surface roughness is adapted to the low thickness of the steel sheet substrate, which in the range for ultra-thin sheets is between 0.1 mm and 0.6 mm. The low surface roughness allows homogeneous surface properties to be achieved, which improve the corrosion resistance of the packaging sheet product even under (mechanical) stress during transport and during forming in forming tools. Furthermore, the low surface roughness means that fewer particles and/or dust of the material of the coating are detached from the surface of the coated sheet packaging product during transport and forming, which means that fewer corrosion-prone areas with a damaged or completely detached coating layer can be developed.

In preferred embodiments of the invention, the (deterministic) surface structures are characterized, for example, by a regularly arranged pattern with periodically recurring elevations. When elevations are referred to in this context, they refer to locations on the surface of the sheet packaging product which protrude by an average height (h) above a surface level averaged over the entire surface. The elevations can be convex or flattened in a plateau shape on their upper side and are surrounded by depressions which are preferably flat or concave. The Ra value measured in the depressions is preferably less than or equal to 0.1 μm.

The elevations expediently have a (mean) height (h) of 0.1 to 8.0 μm, in particular 0.2 to 4.0 μm and preferably less than 3.0 μm. Correspondingly, the (average) depth (t) of the depressions is in the range from 0.1 to 8.0 μm, in particular from 0.2 to 4.0 μm and preferably less than 3.0 μm. Preferably, the periodically recurring structural elements, in particular the elevations or depressions, have a full width at half maximum (“full width at half maximum”, FWHM) of at least 10 μm and in particular in the range of 60 μm to 250 μm.

The elevations can assume various geometric shapes and in particular be rectangular, strip-shaped or bar-shaped, square, cylindrical, leaf-shaped, sickle-shaped, ring-shaped, etc. The elevations can have the same shape or different shapes. The elevations can each have the same shape or different shapes.

Such a surface structure with convex or plateau-shaped protrusions proves to be advantageous in terms of corrosion resistance of the sheet packaging product because, compared with a stochastic surface structure with sharp tips (with a radius of curvature <0.2 mm) on the convex or plateau-shaped flattened upper side of the protrusions, there is less risk of damage to the coating under mechanical load. In the case of the surface structures of sheet packaging products with sharp peaks known from the prior art, there is a risk under mechanical load that the sharp peaks will break off or the coating on the sharp peaks will be detached, resulting in uncoated areas in which the steel of the underlying sheet steel substrate is exposed to environmental influences or the sometimes aggressive filling materials of the packaging and thus tends to oxidize or corrode.

One parameter for the quantitative description of the corrosion properties of tinplate is the so-called IET value, which is measured in the standardized “Iron Exposure Test” and describes the tin porosity of the tin coating. Under constant conditions of the manufacturing process, such as pretreatment (cleaning), total tin coating and constant process parameters, the tin porosity (IET value) depends essentially on the surface roughness (arithmetic mean roughness Ra) and (squared) on the tin coating Sn (in g/m²). For tinplate with a given coating weight Sn of tin (m/A, mass per area in g/m²) and a given mean roughness Ra, the invention can be used in the Iron Exposure Test (IET) to obtain the following current densities. j_{IET}=I/A (electrical current per area in mA/cm²) multiplied by the square of the coating weight Sn (in g/m²) can be obtained:
with a mean roughnesses of Ra≤1.0 μm: j_{IET}·Sn²<1.9 (mA/cm²)·(g/m²)²
with a man roughnesses (Ra) in the range of 1.0 μm<Ra≤2.0 μm: j_{IET}·Sn²<3.3 (mA/cm²)(g/m²)².

A maximum tolerable tin porosity for packaging applications is preferably at IET values <0.5 mA/cm².

A deterministic surface structure with plateau-shaped or convex elevations further proves advantageous in terms of a lower abrasion tendency. Compared to a stochastic surface structure with sharp peaks, which can break off under mechanical stress, there is less risk of damage to the coating and thus abrasion at the plateau-shaped flattenings of the elevations.

To reduce abrasion, it is further advantageous if the surface structure has a plurality of web- or strip-shaped elevations and/or depressions running parallel to one another. If the steel sheet substrate is in the form of a strip extending in a longitudinal direction of the strip, it is useful if the web- or strip-shaped elevations or depressions extend in the longitudinal direction of the strip. The resulting depressions form a reservoir distributed uniformly over the surface of the sheet packaging product for receiving particles of the coating which detach from the coating by abrasion. The particles detached from the coating can be collected in the reservoir of the depressions and are thereby bound to the surface of the sheet packaging product and therefore cannot adhere to and contaminate guide or deflection rollers or forming tools. The depressions, which are distributed evenly over the surface of the sheet packaging product, expediently form open or closed chambers which can receive the particles detached from the coating by abrasion. The chambers formed by the depressions are surrounded by elevations which completely enclose the chambers. However, it is also possible for adjacent chambers to communicate with each other via connecting channels. This allows particles of the coating material to be pushed out of one chamber into an adjacent chamber, for example when transporting the strip over guide or deflection rollers. This makes it possible to distribute the abrasion evenly over the surface of the sheet packaging product and thereby ensure complete absorption of the abrasion in the reservoir formed by the depressions. It is convenient if the height of the elevations or the depth of the depressions is at least substantially homogeneous for all elevations/depressions. In this way, a reservoir for absorbing abrasion is formed which is distributed uniformly over the surface of the sheet packaging product. A sufficient absorption volume of the reservoir can be achieved if the area ratio of the elevations to the total area of the sheet packaging product is between 20% and 50% and preferably between 24% and 45%. Correspondingly, the area ratio of the depressions to the total area of the sheet packaging product is between 50% and 80% and preferably between 55% and 76%.

The setting of defined gloss properties and, in particular, the achievement of high and largely direction-independent gloss values can be achieved if the surface structure has convex or plateau-shaped elevations and groove-shaped depressions. It is expedient for the elevations to be convex or to have a largely flat plateau on their upper side. The groove-shaped recesses have an at least largely flat groove base. The flank walls between the groove base of the recesses and the upper side of the elevations can be vertical or inclined to the vertical (e.g. in the form of a cone or a truncated cone). In cross-section, the elevations have, for example, a rectangular or trapezoidal shape. For manufacturing reasons, the cross-sectional shape is usually that of an isosceles trapezoid which tapers towards the surface.

A regularly arranged pattern with elevations and/or depressions leads to an optically homogeneous surface and thus to an improvement of the gloss properties. An optically homogeneous surface can be achieved if the elevations and the depressions are at least substantially equal in size. In particular, if the structural elements comprise depressions with an at least substantially planar depression base, it is advantageous for achieving high gloss values if the areas of the depression base of the individual structural elements are at least substantially equal in size.

With packaging sheet products according to the invention, gloss values of more than 50 gloss units (GU) and preferably more than 100 gloss units (GU), in particular between 100 and 800 gloss units (GU), can be achieved in this way with a surface roughness (Ra) of less than 0.5 μm and more than 0.1 μm. The gloss properties are characterized by a high isotropy in the plane of the surface. The surface of the packaging sheet products can have a gloss value which is at least substantially independent of direction, the difference in gloss value (Δgloss) in the rolling direction and a transverse direction perpendicular thereto preferably being less than 100 gloss units (GU) and particularly preferably being 70 gloss units (GU) or less, in particular at a surface roughness (Ra) of 0.01 to 2.0 μm.

If necessary, the sheet packaging products according to the invention can be provided with further coatings or overlays. For example, the tinplate products according to the invention can be passivated with a chromium/chromium oxide coating or also by wet-chemical application of a chromium-free passivation layer to prevent unhindered oxidation of the tin surface. Furthermore, organic coatings, such as organic lacquers or polymer coatings of thermoplastic polymers such as PET, PP or PE or mixtures thereof, can be applied to the surfaces of the sheet packaging products according to the invention in order to increase the corrosion resistance and the resistance to acids and sulfur-containing materials and the formability of the material.

### BRIEF DESCRIPTION OF THE DRAWINGS

These and other advantages and features of the invention will be apparent from the embodiments described in more detail below with reference to the accompanying drawings. The drawings show:

FIGS. 1A and 1B: Schematic representation of sheet packaging products according to the invention in a sectional view, wherein FIG. 1A shows a sheet packaging product consisting of a sheet steel substrate and a coating and FIG. 1B shows a sheet packaging product consisting of a sheet steel substrate with a coating and a support applied thereto;

FIG. 2: Enlarged schematic sectional view in the area of the surface of the coating of a sheet packaging product according to the invention;

FIGS. 3A and 3B: Schematic sectional view in the surface area of a sheet packaging product according to the prior art (FIG. 3A) and according to the invention (FIG. 3B), in each case before (left side) and after (right side) application of the coating to the sheet steel substrate;

FIG. 4A: Microscopic view of the surface of a conventional prior art sheet packaging product with an associated surface profile (height profile), wherein the surface of the steel sheet substrate has been skin-pass rolled by a blasted or ground dressing roll prior to application of the coating;

FIGS. 4B to 4G: Height profiles of the surface of surface-structured skin pass rolls (left side in each case) and of the surfaces of packaging sheet products according to the invention skin passed with this skin pass roll before (FIGS. 4B, 4C and 4D) or after (FIGS. 4E, 4F and 4G) the electrolytic application of the coating (right side in each case);

FIG. 5A to 5G: Three-dimensional microscopic representations of surface profiles of the steel sheets according to FIGS. 4A and 4B to 4G (in each case at the top of the figure), together with a roughness profile of the surface (in each case at the bottom) and the autocorrelation function resulting from the roughness profile (in each case in the middle of the figure), wherein the microscopic representation of the surface, the roughness profile and the associated autocorrelation functions in each case before electrolytic deposition of a tin coating (FIGS. 5B, 5C and 5D, left), after electrolytic deposition of a tin coating (FIG. 5A, left or FIGS. 5B, 5C and 5D, center) and after (right side in each case) melting of the tin coating;

FIG. 6: Representation of the IET values measured in the “Iron Exposure Test” (IET) on tinplate according to the invention and the prior art, multiplied by the square of the tin coating as a function of the surface roughness (arithmetic mean roughness Ra in μm) of the tinplate samples;

FIG. 7: Depiction of the dependence of gloss values measured on tinplate according to the invention and the prior art (in gloss units GU) on the surface roughness (arithmetic mean roughness Ra in μm);

FIG. 8: Depiction of the dependence of the isotropy of the gloss values measured on tinplate according to the invention and the prior art (as Δgloss values in gloss units GU) on the surface roughness (arithmetic mean roughness Ra in μm);

### DETAILED DESCRIPTION

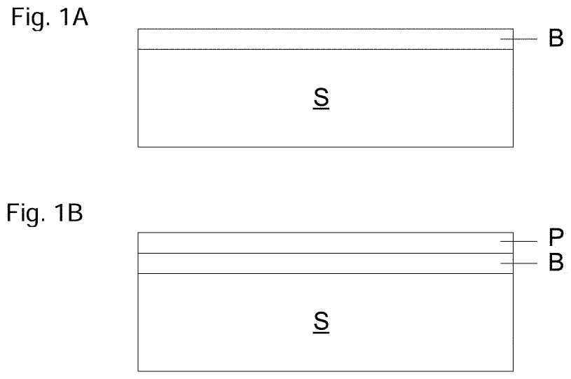

FIG. 1A shows a schematic section of a packaging sheet product. The packaging sheet product consists of a sheet steel substrate S with a thickness in the ultra-thin sheet range (0.1 mm to 0.6 mm) and a coating B deposited electrolytically on the sheet steel substrate S. The sheet steel substrate is a cold-rolled steel sheet made of a steel with a low carbon content. Suitable compositions of the steel of the sheet steel substrate S are defined in the European standard DIN EN 10 202. The sheet steel substrate S preferably has the following composition in terms of the weight fractions of the alloying components of the steel:
C: 0.01-0.1%,
Si: <0.03%,
Mn: 0.1-0.6%
P: <0.03%,
S: 0.001-0.03%,
Al: 0.002-0.1%,
N: 0.001-0.12%, preferably less than 0.07%.
optionally Cr: <0.1%, preferably 0.01-0.05%,
optionally Ni: <0.1%, preferably 0.01-0.05%,
optionally Cu: <0.1%, preferably 0.002-0.05%,
optional Ti: <0.09%,
optional B: <0.005%,
optional Nb: <0.02%,
optional Mo: <0.02%,
optional Sn: <0.03%,
Residual iron and unavoidable impurities.

The coating B can be a tin coating or a coating of chromium and chromium oxide (and possibly chromium hydroxides). In the case of a tin coating, we speak of tinplate. In the case of a chromium/chromium oxide coating that has been electrolytically deposited on the steel sheet substrate, it is referred to as Electrolytic Chromium Coated Steel (ECCS). In the case of tinplate, the coating weight of the coating B is typically in the range from 1 to 15 g/m² and, in particular, between 2 and 6 g/m² of tin. For ECCS, the coating weight of chromium in the chromium-chromium oxide layer is typically in the range of 50 to 200 mg/m² and in particular between 70 and 150 mg/m².

Further coatings or overlays, for example in the form of passivation layers or organic overlays such as lacquers or polymer coatings, can be applied to the coating B in this process. This is shown schematically in FIG. 1B, where an overlay P is shown on the coating B. The overlay P can be, for example, a white lacquer coating. In the case of tinplate, for example, the overlay P can be a passivation layer. The passivation layer can be composed of metallic chromium and/or chromium oxide, as is usual for tinplate. However, the passivation layer can also be a chromium-free passivation layer applied wet-chemically onto the tin surface. In the case of tinplate, the passivation layer is intended to prevent unhindered oxide growth on the tin surface and thus ensure storage stability of the tinplate over longer periods without oxidation of the tin surface. Furthermore, in the case of tinplate, the surface of the coating or the entire tin coating can be melted after its electrolytic deposition on the steel sheet substrate by heating the tinplate to temperatures above the melting temperature of tin.

The overlay P can also be formed by an organic overlay, such as an organic lacquer or by a polymer coating made of a thermoplastic polymer, in particular PET or PP. In particular for ECCS, it is common to coat the chromium oxide surface of the ECCS with a polymer coating made of a thermoplastic polymer, for example by laminating a PET or PP film, in order to improve the corrosion resistance and the resistance of the material to acids and also the formability of the material.

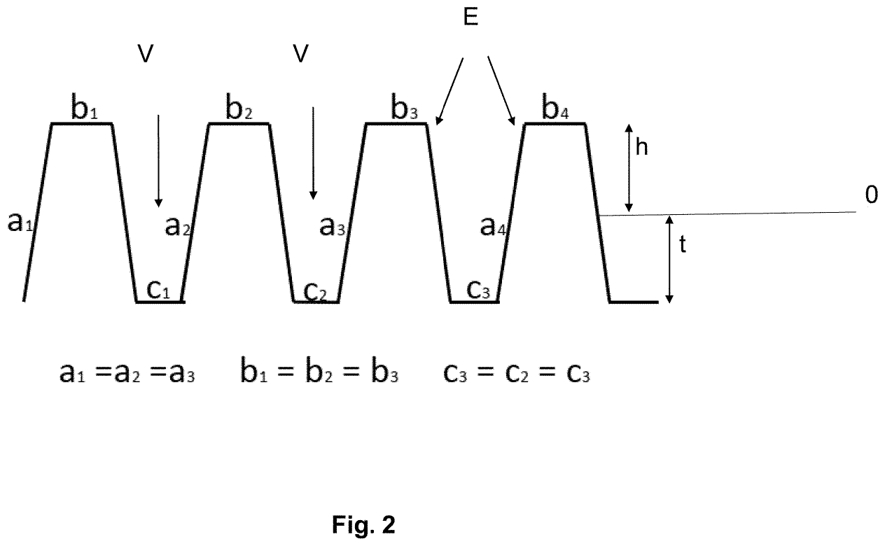

FIG. 2 shows a schematic representation of a sheet packaging product according to the invention in the region of the surface of the coating B. As can be seen from FIG. 2, the surface of the sheet packaging product has a plurality of elevations E (in the sectional view shown) arranged next to one another and depressions V located in between. The elevations E have a (mean) height h above an average surface level 0. The depressions V have a depth t relative to the average surface level 0. The depressions V are groove-shaped with an at least largely flat groove base c1, c2, c3. The elevations E are plateau-shaped with a substantially flat plateau surface b1, b2, b3, b4. The flanks a1, a2, a3, a4 of the depressions V and the elevations E are slightly inclined with respect to the vertical plane, as shown in FIG. 2. In the sectional view shown in FIG. 2, this results in isosceles trapeziums or truncated cones for the shape of the elevations E, which taper conically towards the surface (Gaussian or Tophat profile).

To achieve homogeneous surface properties, it is useful if the shape and arrangement of the elevations E and the depressions V are as uniform or regular as possible.

In particular, the areas of the groove bases c1, c2, c3 of the groove-shaped recesses V are as equal as possible. Deviations are preferably less than or equal to 10%. In a corresponding manner, the plateau areas (b1 to b4) of the plateau-shaped elevations are also preferably approximately the same size and the flanks a1-a4, which extend between the depressions V and the elevations E adjacent thereto, also preferably show no differences in inclination. The heights h of the elevations can vary by a maximum of 25% and the depths t of the depressions also preferably vary only slightly by about 10% or less.

The uniformity and regularity of the surface structures of the sheet packaging products according to the invention can be described mathematically with the aid of autocorrelation. The autocorrelation (also cross autocorrelation) generally describes the correlation of a signal or a profile z(x) with itself at an earlier time or at another location x.

Without shifts Ψ_{zz}(0) represents the variance of the height values z(x) of the profile with x in the interval from 0 to l:

$${Ψ}_{zz} ( 0 ) = \frac{1}{l} {\int }_{0}^{l} z ( {x}^{′} ) \cdot z ( {x}^{′} + 0 ) {dx}^{′} = {σ}^{2} ( Variance ) = {R}_{q}^{2}$$

For calculating of roughness parameters, in accordance with DIN EN ISO 4288:1998-04, in the roughness range Ra=0.1 μm to 1 μm a scanning distance of lₜ of 4.8 mm should be used. After Gaussian high-pass filtering with cut-off wavelength L_{c}=0.8 mm and separation of the marginal areas, this leaves for the characteristic value calculation an evaluation length of l=4 mm.

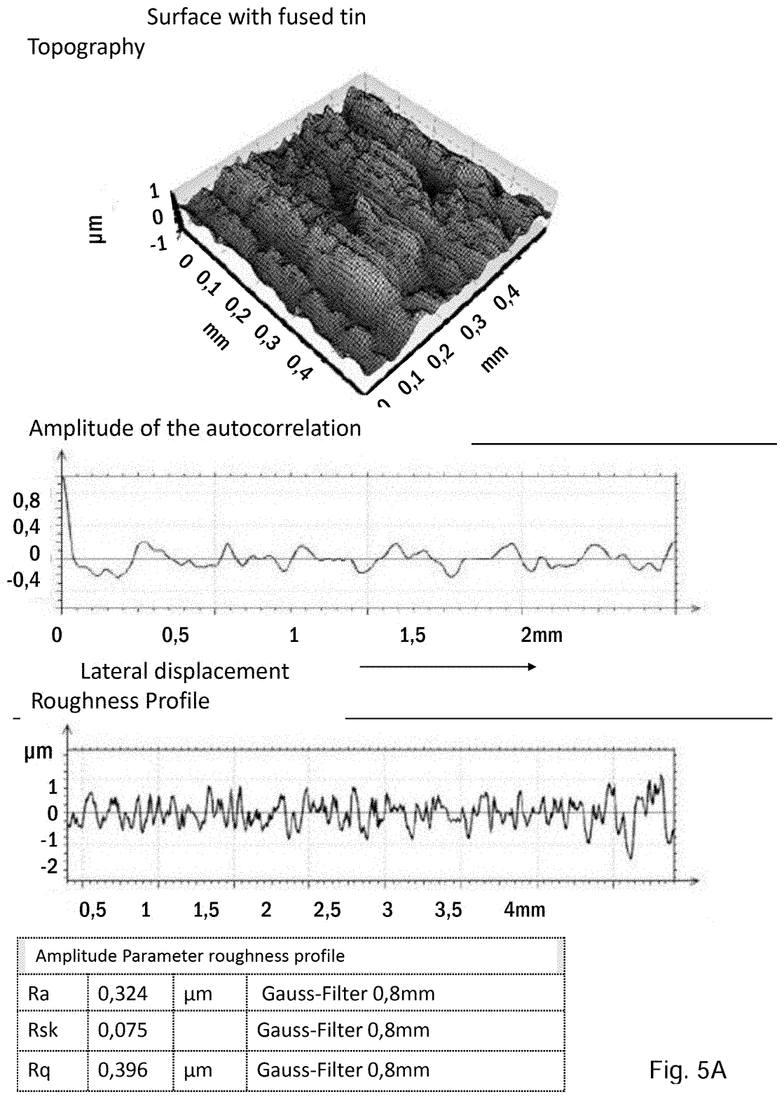

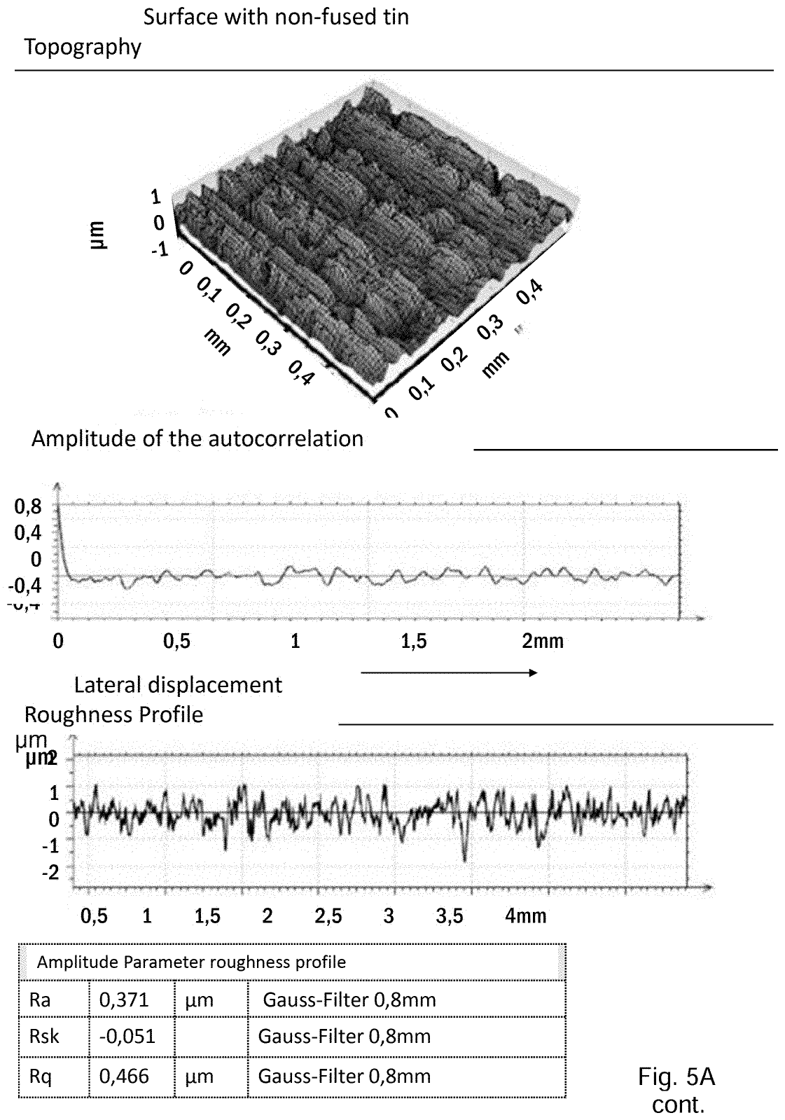

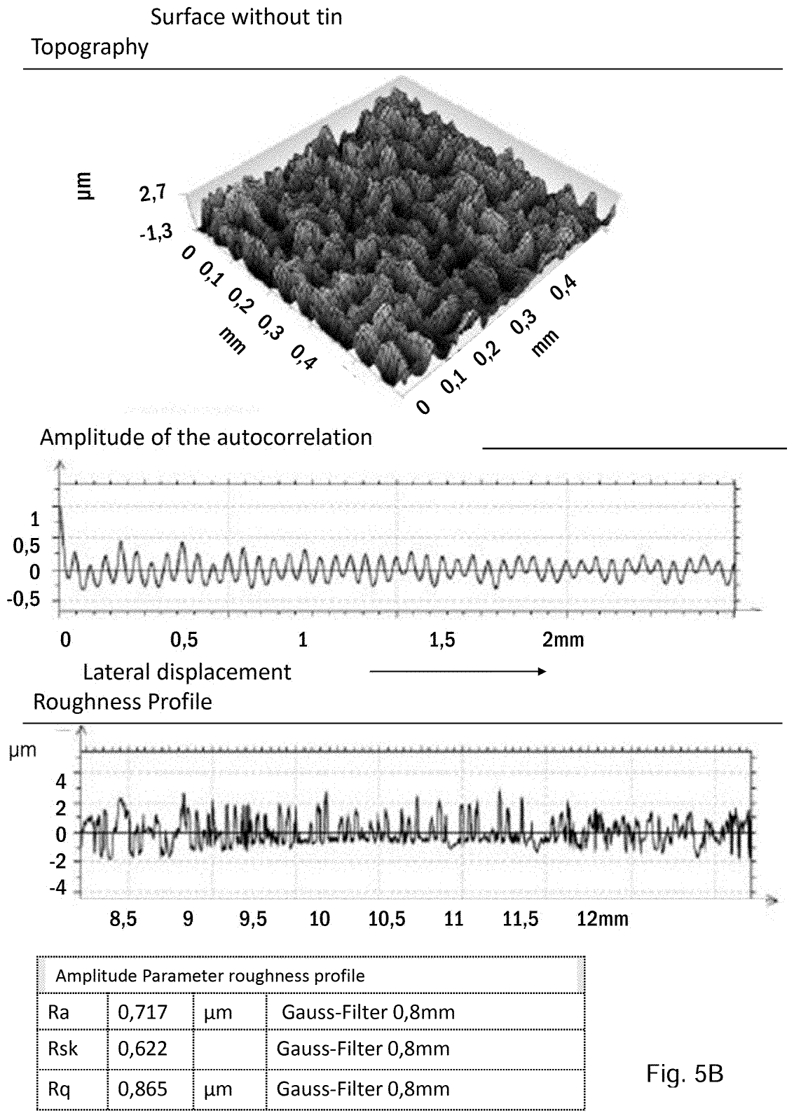

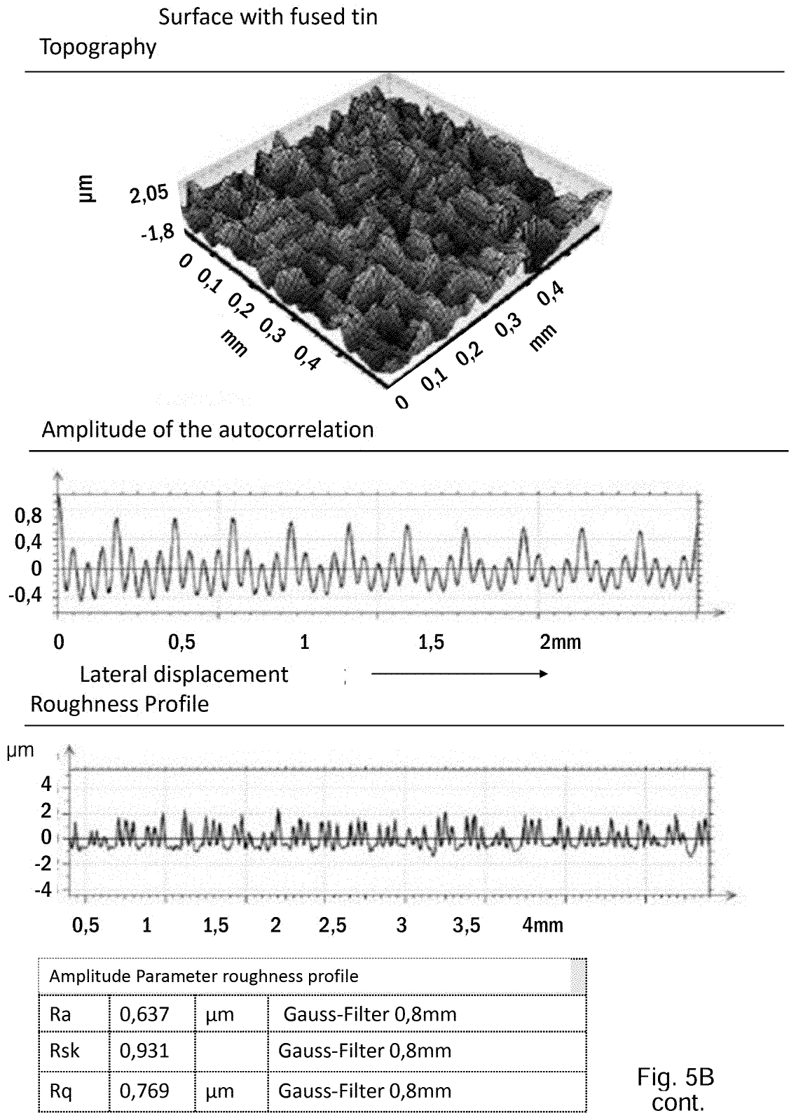

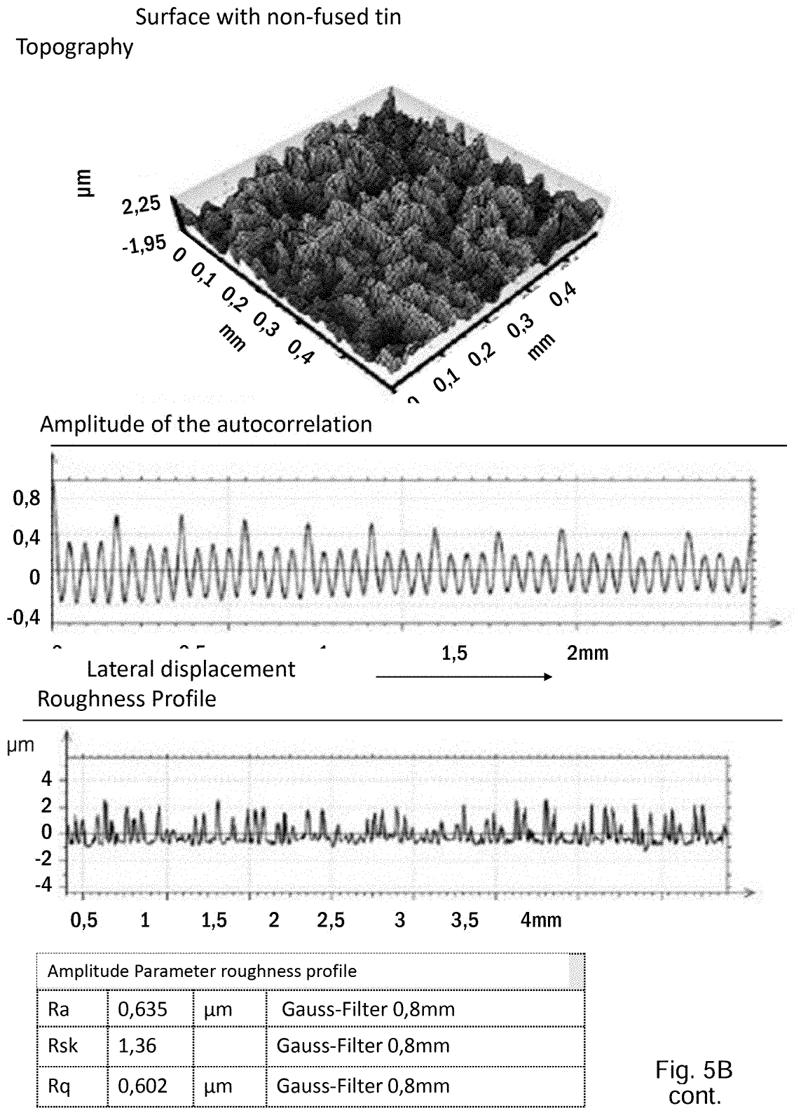

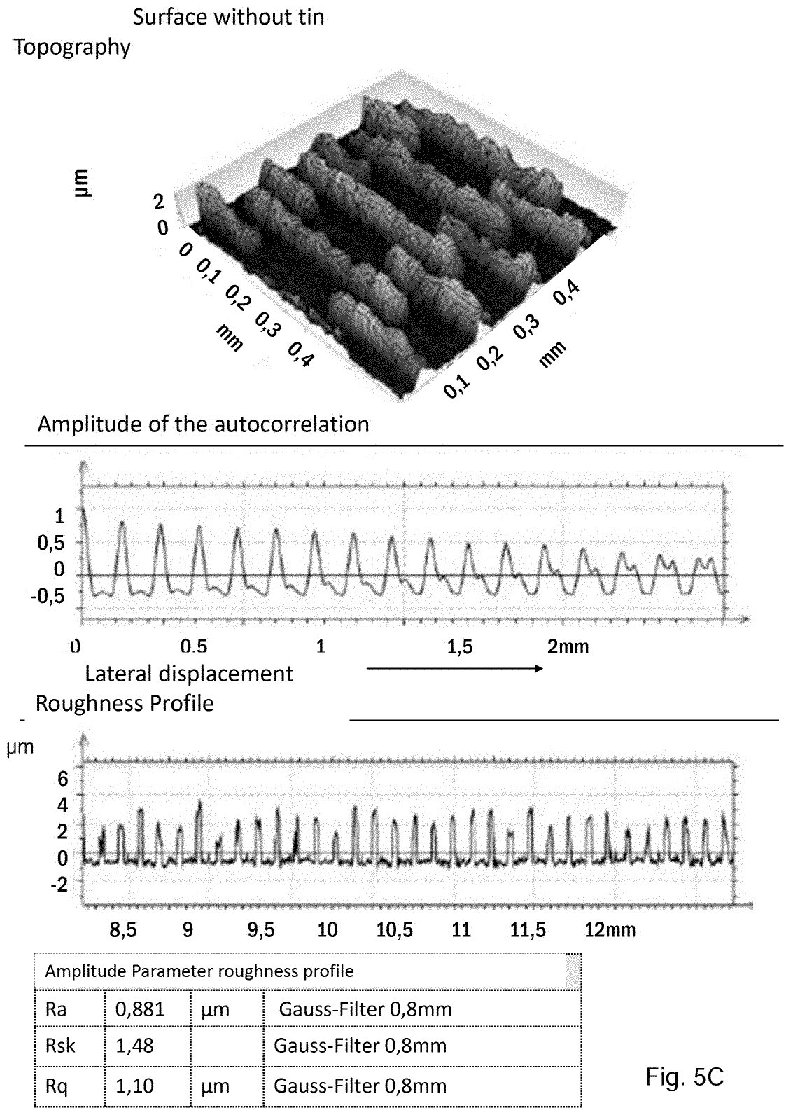

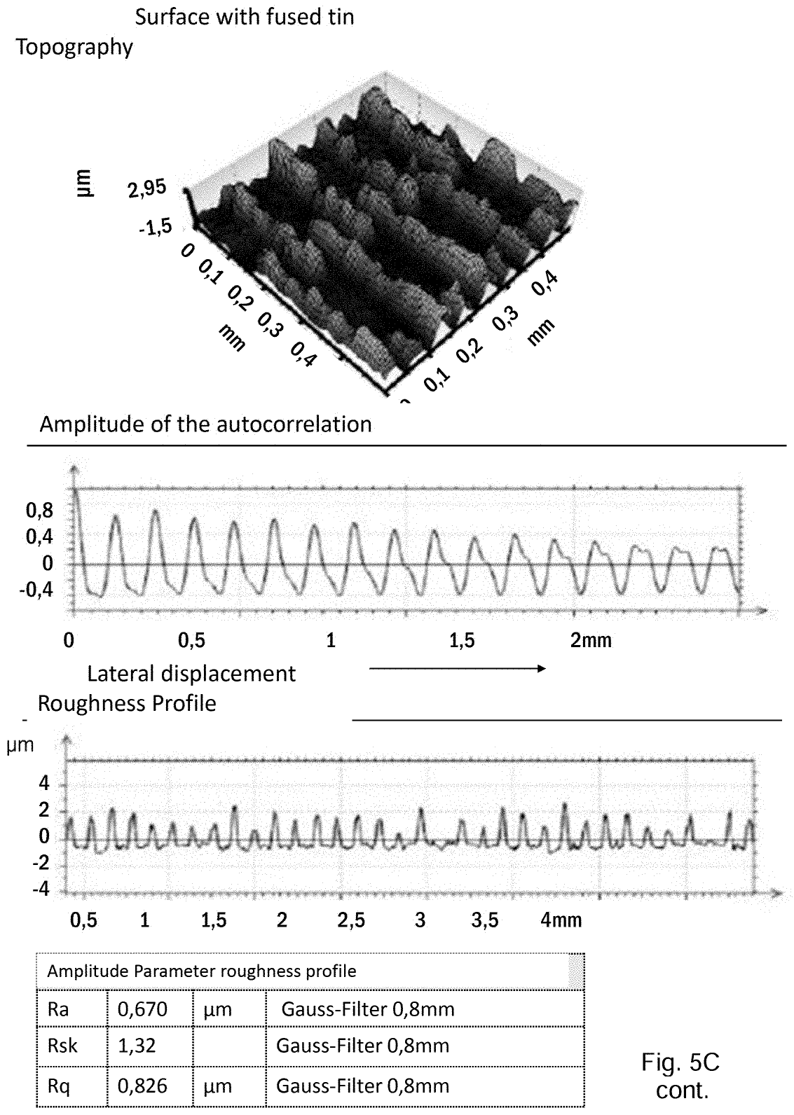

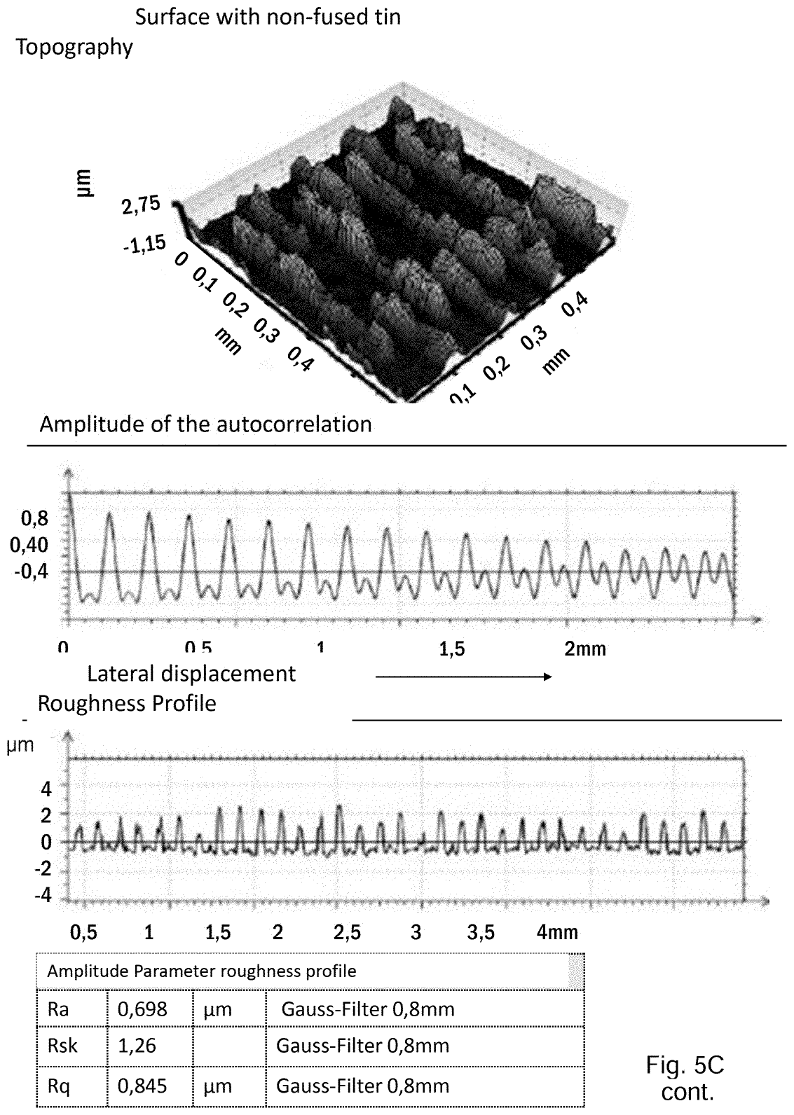

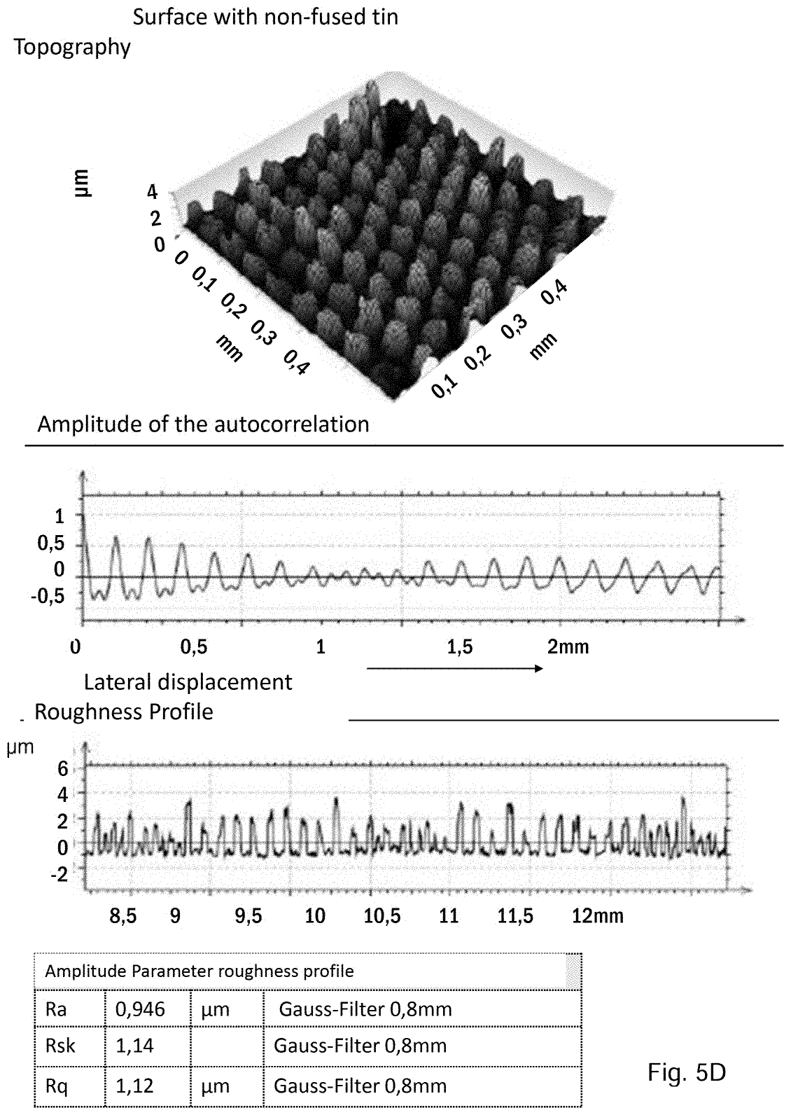

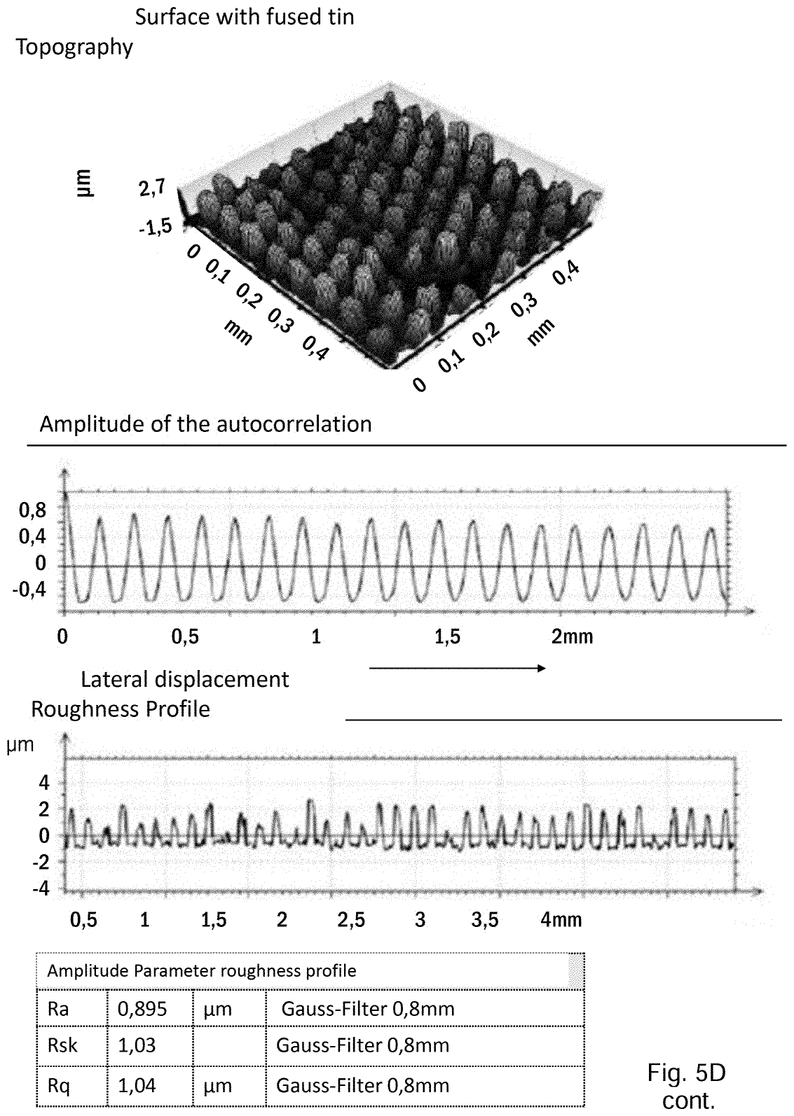

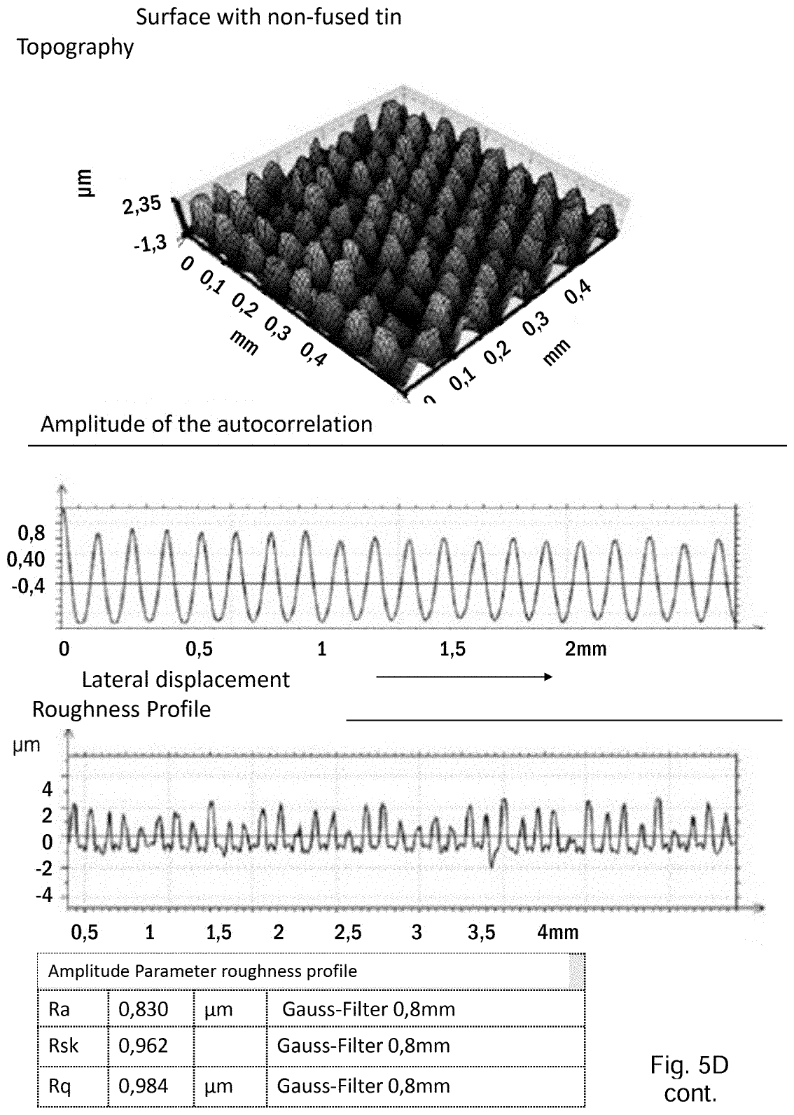

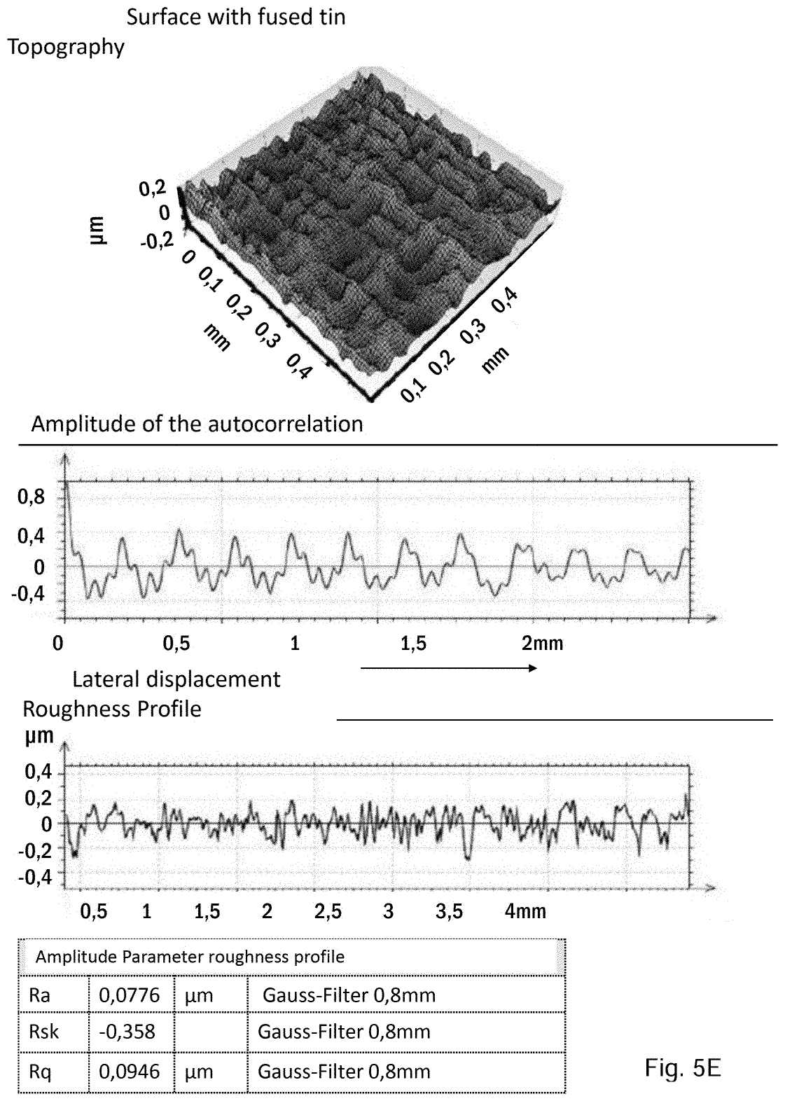

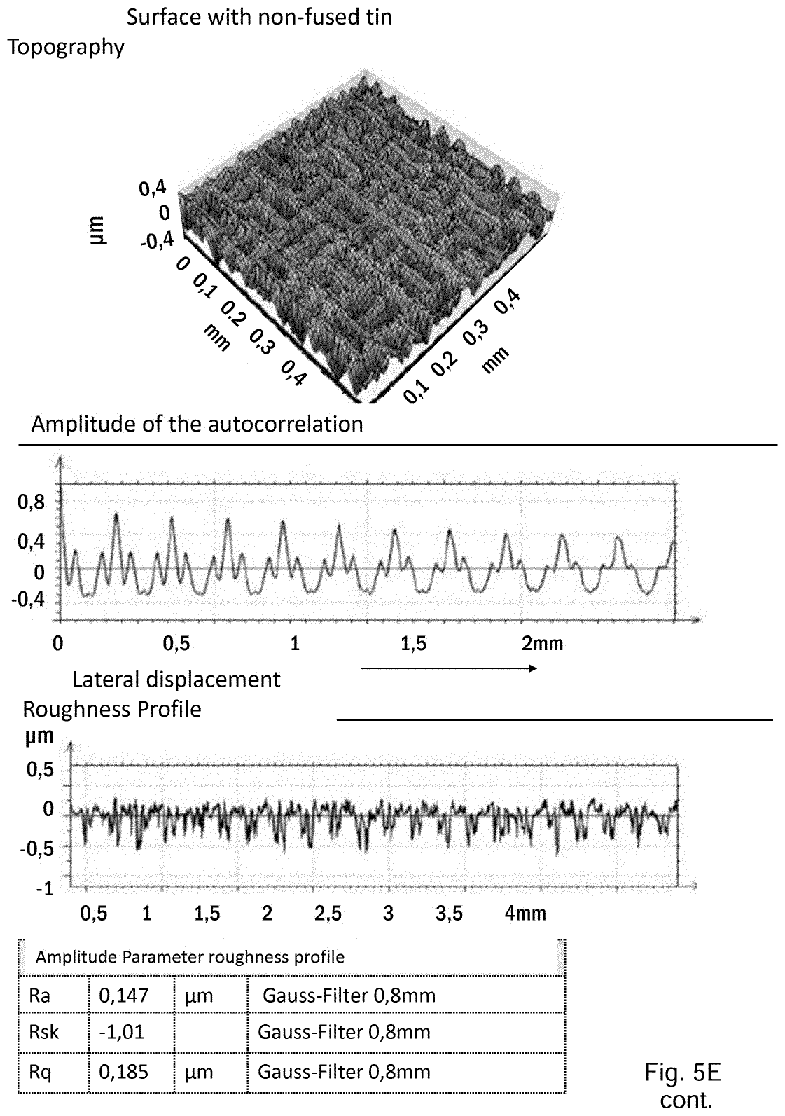

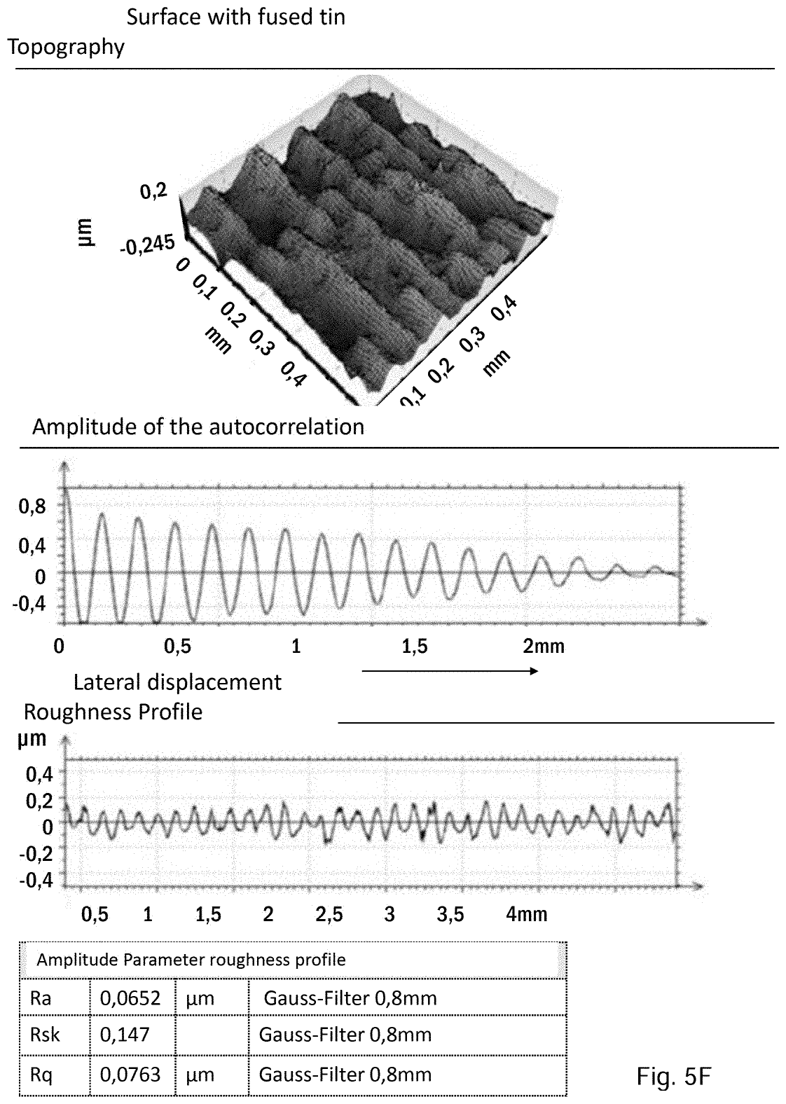

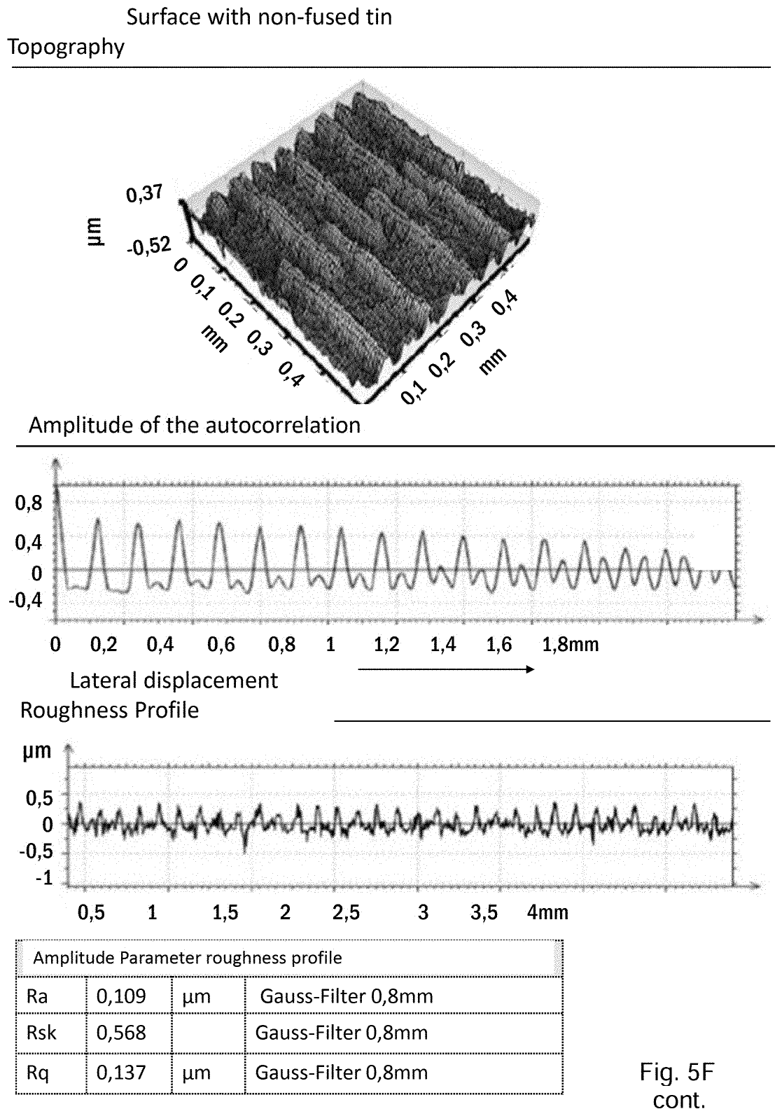

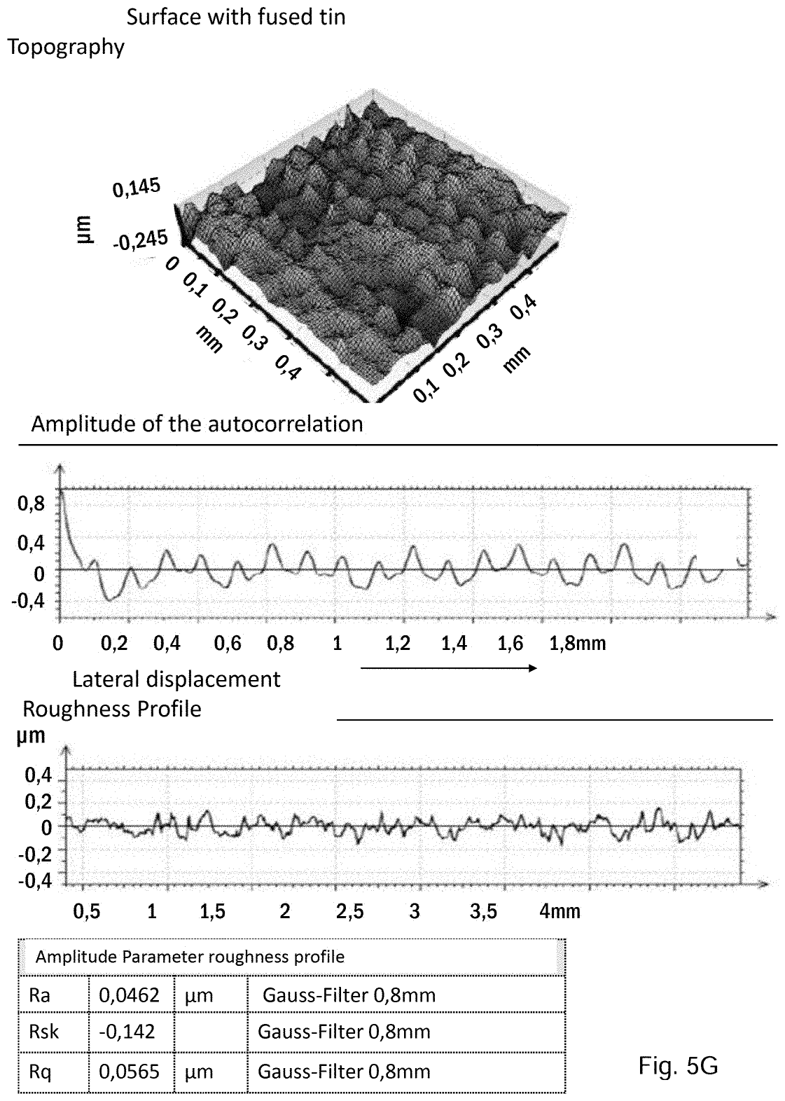

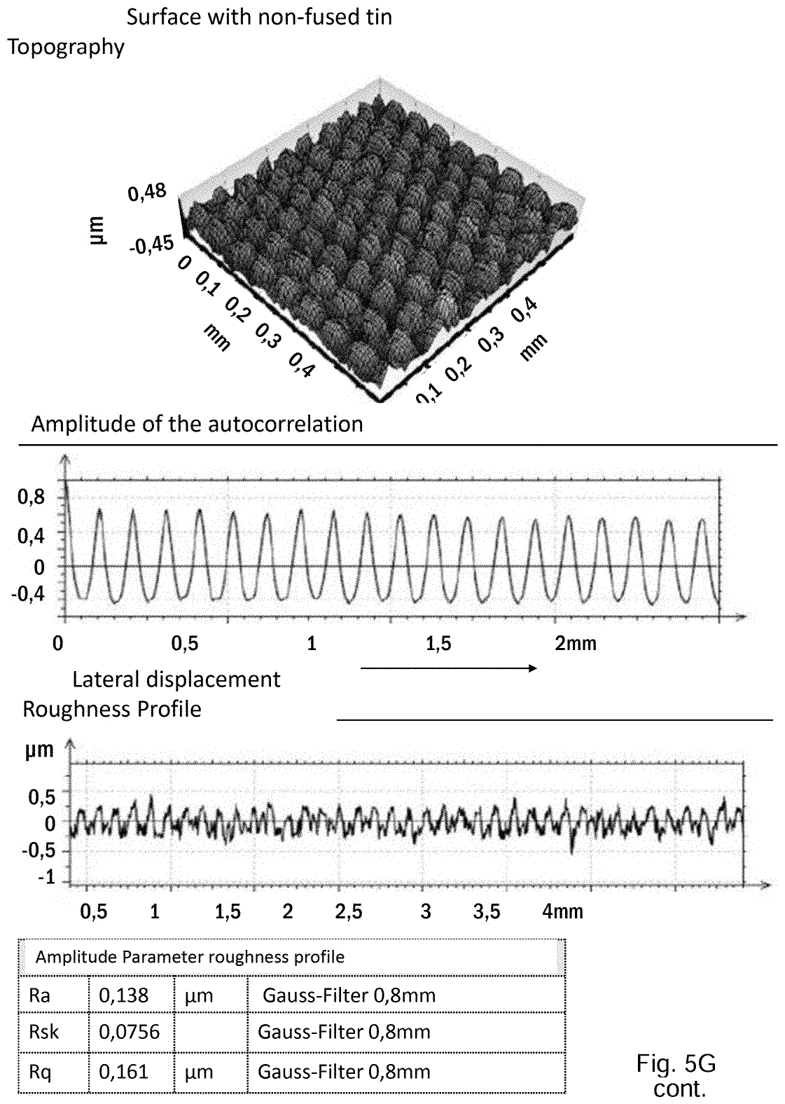

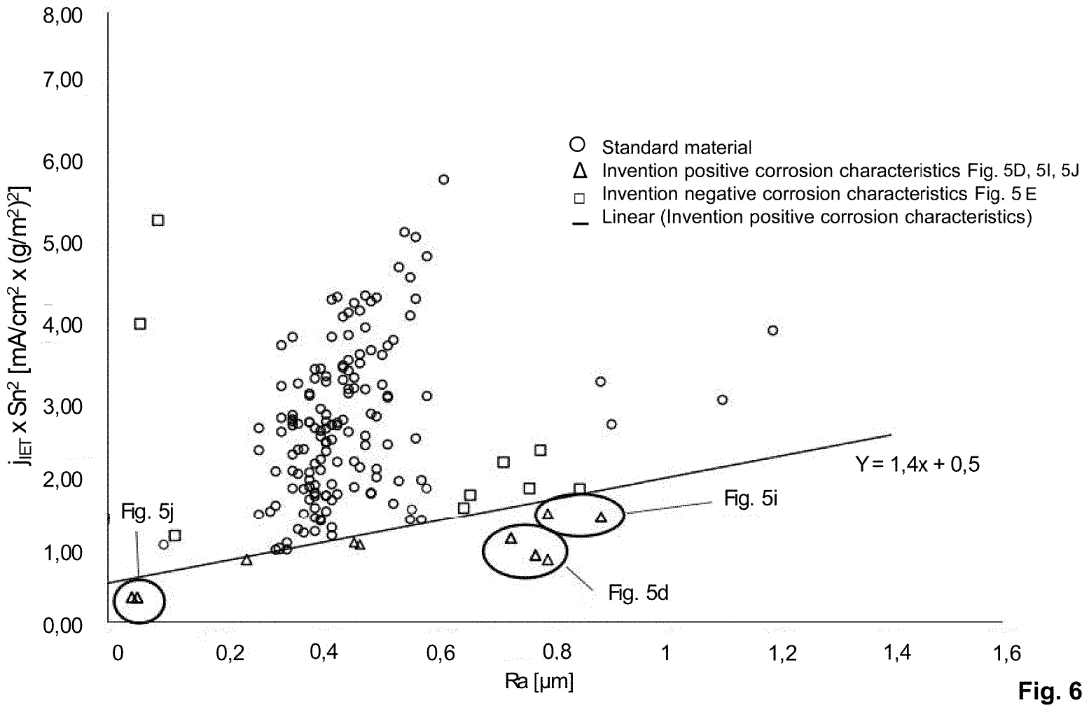

FIGS. 5A and 5B to 5G show (in each case in the bottom of the figure) surface profiles (roughness profiles) of a conventional sheet packaging product (FIG. 5A) and of sheet packaging products according to the invention (FIGS. 5B to 5G) and associated autocorrelation functions of the surface profile (in each case in the middle of the figure). Here, FIG. 5A shows the surface structure of tinplate with a conventional steel substrate with a statistically uncorrelated surface structure. FIGS. 5B to 5D show the surface structure of steel sheets according to the invention before coating with tin (left side) and after electrolytic coating on both sides with a tin coating of 2.8 g/m² (center and right side of the figure), with the center image showing the tin surface in the molten state and the right image showing the tin surface before melting in each case. FIGS. 5E to 5G show further examples of the surface structure of tinplate according to the invention (before and after a re-melting of the tin coating).

The amplitudes of the autocorrelation are normalized with respect to the main maximum H (at x=0) (normalized autocorrelation function

$$\frac{{Ψ}_{zz} ( x )}{{σ}^{2}} ) .$$

The height of the secondary maxima N of the normalized autocorrelation function, which can be a maximum of 1 or 100% because of the normalization, represent a measure of the regularity and uniformity of the autocorrelation periodically along the selected direction (x) in the surface plane. Because of their symmetry property (Ψ(−x)=Ψ_{zz}(x)), the autocorrelation function is shown in the figures only for positive x values; for negative values, it behaves as a mirror image of the ordinate. To determine the highest (secondary) maxima of the autocorrelation of the surface profile, the measuring section should, if possible, be placed in one of the preferred directions of the specimen, in particular in the longitudinal direction of the strip (or the rolling direction of the cold-rolled packaging sheet) or perpendicular to it.

A comparison of the non-inventive comparative sample according to FIG. 5A with the sheet packaging products according to the invention (FIGS. 5B to 5G) shows that the sheet packaging products according to the invention have an autocorrelation function which, in addition to the main maximum at x=0, has several secondary maxima which reach an amplitude of at least 20% of the main maximum, whereas the height of the secondary maxima in the non-inventive comparative sample is (significantly) less than 20%. The sheet packaging products with a deterministic surface structure according to the invention thus have a much more uniform surface profile with periodically recurring structural elements.

The shape of the periodically recurring structural elements, in particular the elevations E and the depressions V, can be adapted in each case to the application of the sheet packaging products according to the invention or to the specifications for producing packaging therefrom. Suitable cross-sectional shapes for the elevations E and the depressions V can be essentially trapezoidal and dome-shaped.

The elevations E and depressions V can also be circular or annular in shape. For special applications, in particular to achieve homogeneous optical properties such as reflectivity and gloss, elevations E or depressions V in the form of strips or ridges have proved advantageous. The protrusions E can be convex or, in a preferred manner, have a plateau-shaped flattened upper surface which is as flat as possible. The recesses V have a largely flat recess surface.

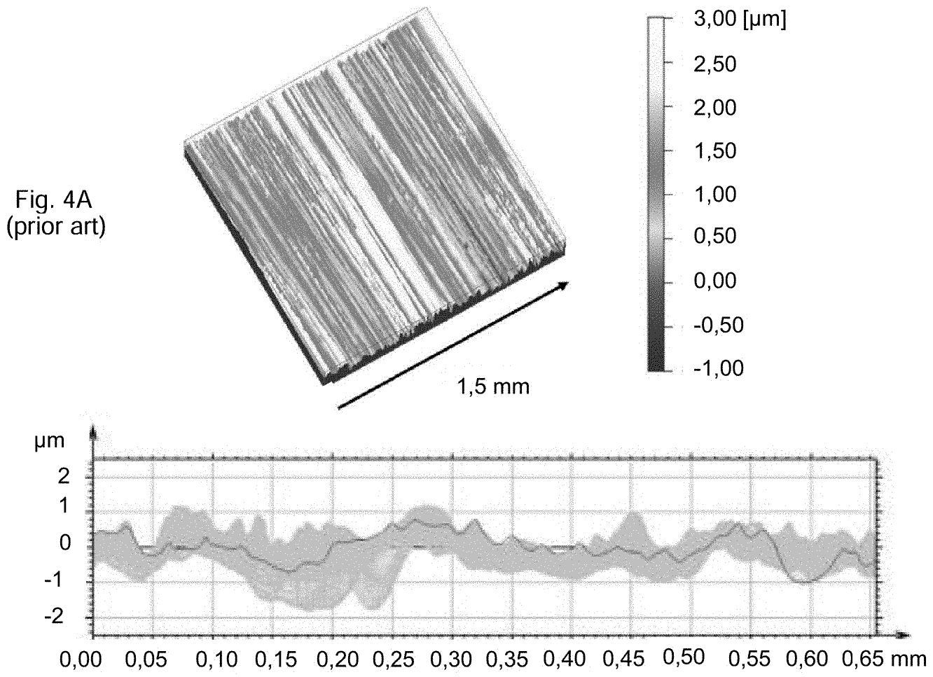

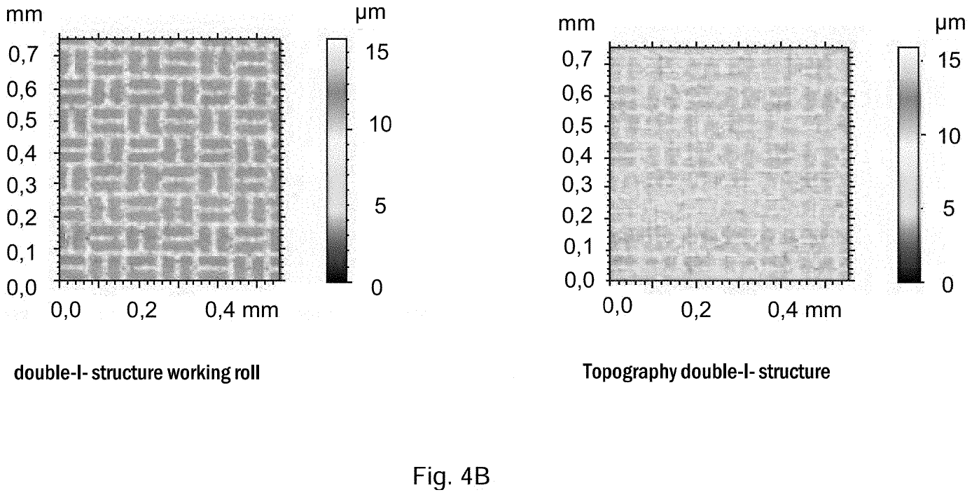

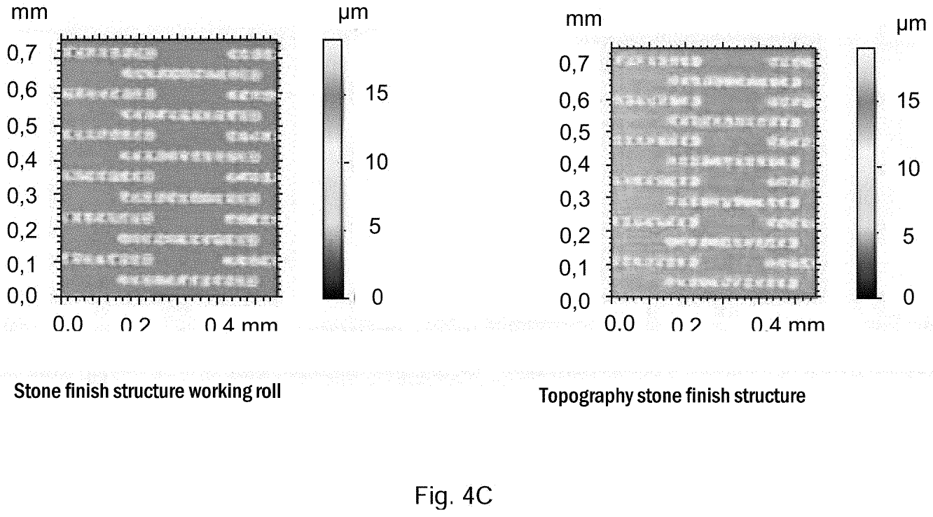

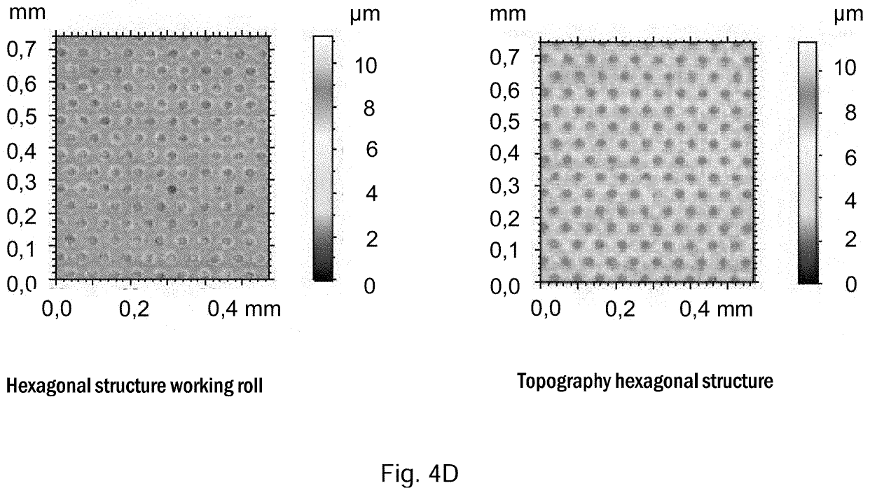

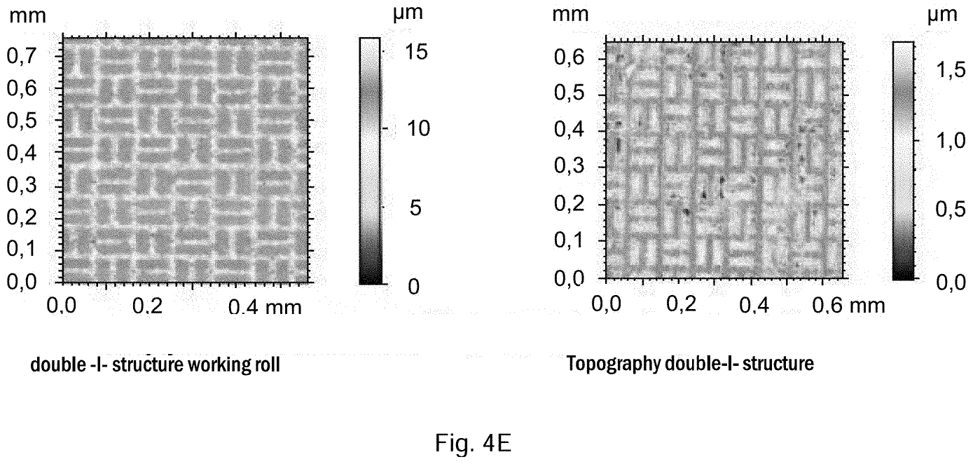

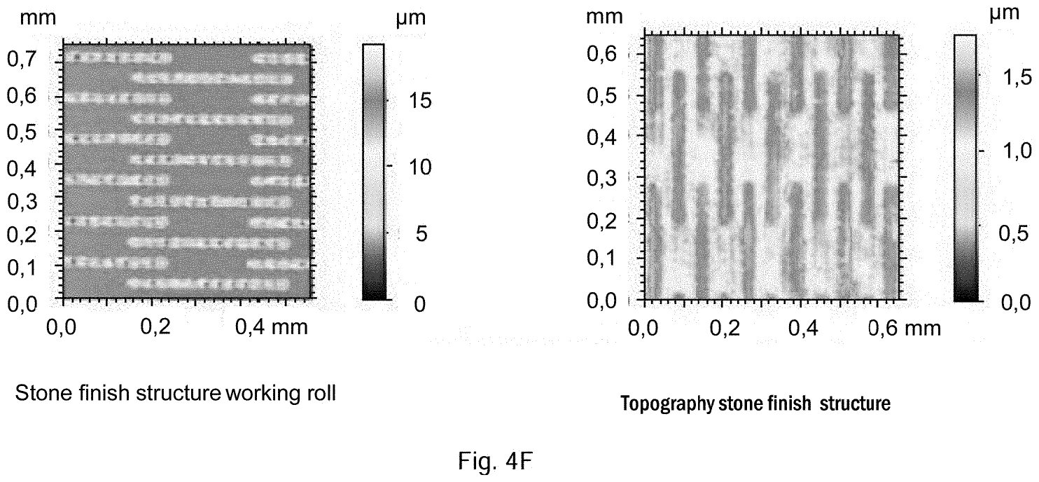

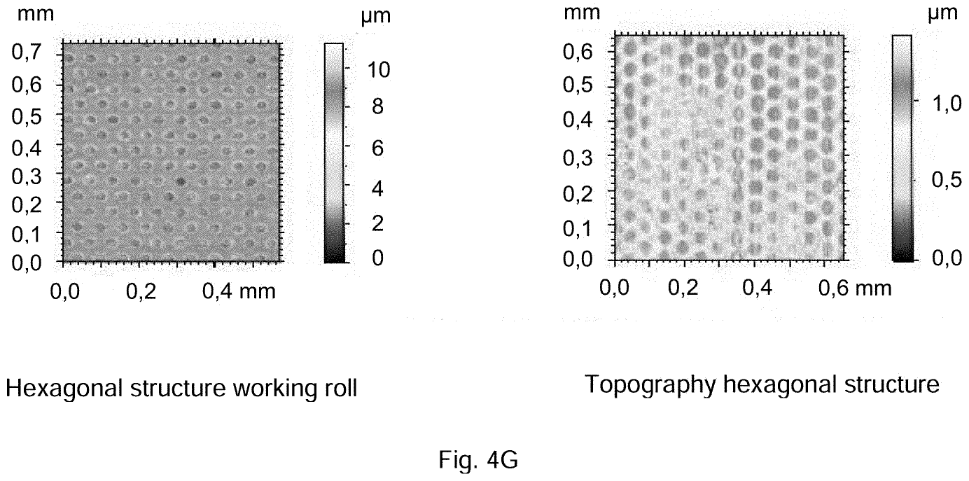

Examples of surface structures with periodically recurring structural elements are shown in FIGS. 4B to 4G, in each case depicting (in a plan view with associated height profile) on the left-hand side the surface of the work roll with which the sheet steel substrate was cold-rolled (skin-passed) prior to the electrolytic application of the coating B, and on the right-hand side depicting in each case the resulting surface structure of the skin-passed surface of the sheet steel substrate. The data for the rolls (pairs) used in the secondary cold rolling (skin pass) of the steel sheet substrate can be taken from Table 1.

In the examples of FIGS. 4B to 4D, a re-rolling mill was used for the re-rolling (secondary cold rolling) of the steel sheet substrate, which was equipped in a first stand with a first work roll with a blasted roll surface and in a second stand with a second work roll with a structured roll surface. The surface structure of the structured roll surface of the second work roll is shown in FIGS. 4B to 4D on the left of the figure.

In the examples of FIGS. 4E to 4G, a re-rolling mill was used for secondary cold rolling of the steel sheet substrate, which was equipped in a first stand with a first work roll having a structured roll surface and in a second stand with a second work roll having a polished roll surface. The surface structure of the structured roll surface of the first work roll is shown in FIG. 4E to 4G on the left of the figure.

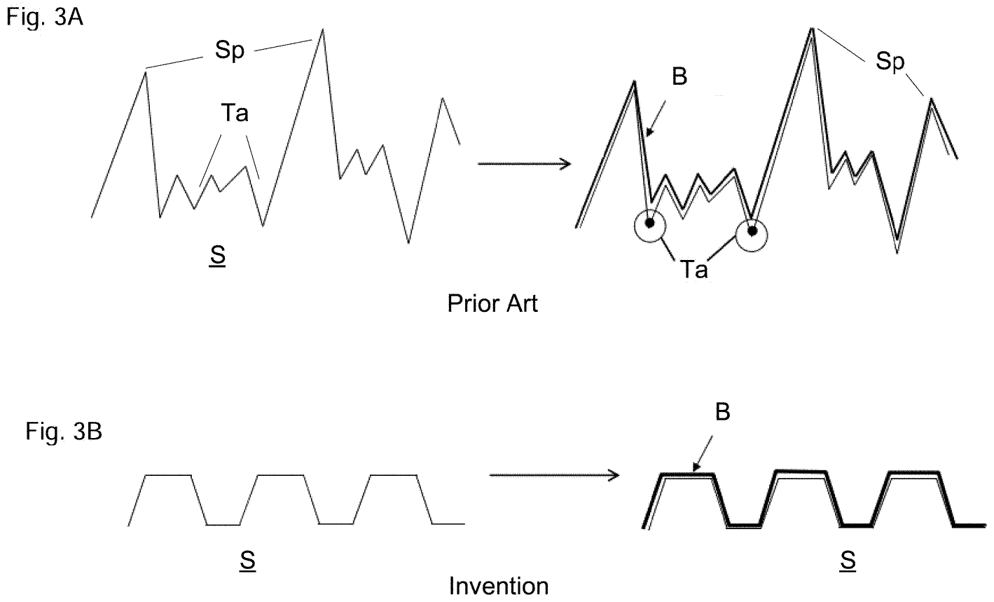

The surface topographies of the sheet packaging products according to the invention shown in FIGS. 3B to 3J allow a surface roughness with an arithmetic mean roughness Ra to be set which is uniformly distributed over the surface, the arithmetic mean roughness Ra preferably being in the range from 0.01 to 2.0 μm and particularly preferably in the range from 0.1 to 1.0 μm and in particular in the range from 0.1 to 0.3 μm. The surface roughness, in particular the value for the arithmetic mean roughness Ra, of the sheet packaging products according to the invention can be adapted to the particular application and specifically set by selecting the geometry and size of the periodically recurring surface structures (elevations E and depressions V).

For the production of the sheet packaging products according to the invention, the sheet steel substrate S is re-rolled with a surface-structured roll after or during (primary) cold rolling (secondary cold rolling with a degree of re-rolling in the range of 5% to 45%) or is dressed with a degree of re-rolling of less than 5%. The surface-structured work rolls used for this purpose can be, for example, rolls structured with a short-pulse laser (KPL) or with an ultrashort-pulse laser (UKPL). In Table 1, the rolls structured with an ultrashort pulse laser are designated with the abbreviation “UKPL”. It should be noted that despite this designation, the invention is not limited to the production of the deterministic surface structure by means of a roll structured with an ultrashort pulse laser (UKPL). The surface structures of the sheet packaging products according to the invention can also be imprinted by rollers structured in other ways. In any case, however, the rolls used for this purpose have a deterministically structured roll surface which is impressed into the surface of the sheet steel substrate S during rolling. It is expedient to imprint the surface structure of the roll in a secondary cold rolling step with a reduction degree (re-rolling degree) of more than 5% up to a maximum of 50% or in a skin-passing step in which the cold-rolled steel sheet is skin-passed with a low reduction degree of a maximum of 5% after primary cold rolling.

After the deterministic surface structure of the work roll (skin pass roll) has been introduced into the surface of the steel sheet substrate S, the coating B is applied according to the invention by electrolytic deposition of the coating material (e.g. tin in the case of tinplate and chromium/chromium oxide in the case of ECCS) onto the structured surface of the steel sheet substrate S. The coating B is then applied to the steel sheet substrate S by electrolytic deposition. During the electrolytic deposition of the coating B on the sheet steel substrate S, the deterministic surface structure of the sheet steel substrate is essentially retained, so that the coated sheet packaging product also has a deterministic surface structure with a uniform topography, as shown schematically in FIG. 2. The deterministic surface structure is also preserved when an additional overlay P is applied to the coating B, as shown in FIG. 1B, in particular when the overlay P is applied to the coating B in the form of a liquid, for example in the form of an aqueous passivation solution or a liquid paint or a molten polymer material. It is true that the application of the coating B reduces the (relative) height of the secondary maxima of the autorrelation function by an average of 10 to 20% compared with the uncoated steel sheet substrate. However, the process according to the invention enables to achieve surface structures of the coated sheet packaging product whose autocorrelation function has a plurality of secondary maxima with a (relative) height of at least 20% of the main maximum.

The deterministic surface structure of the suitably produced sheet packaging products according to the invention eliminates many problems that can arise in the conventional production of sheet packaging products (especially tinplate and ECCS). Typical problems arising in the conventional manufacture of sheet packaging products are explained below with reference to FIG. 3, where FIG. 3A shows the surface of conventionally manufactured sheet packaging products before and after application of the coating B to the substrate S, and FIG. 3B shows schematically the surface of sheet packaging products according to the invention, which can eliminate the problems of the prior art.

FIGS. 3A and 3B schematically show a sectional view of a sheet steel substrate S before (left side) and after (right side) application of a coating B, where FIG. 3A shows a conventionally produced substrate or sheet packaging product with a stochastic, disordered surface structure and FIG. 3B shows a substrate treated in accordance with the invention or a sheet packaging product treated in accordance with the invention with a deterministic surface structure. As can be seen from FIG. 3A, the surface of the steel sheet substrate S and the packaging sheet product coated with the coating B has a statistical (i.e. a non-deterministically predetermined) surface topology with peaks Sp and valleys Ta. The height of the peaks Sp and the depth and/or geometry of the valleys Ta are non-uniform, i.e. inhomogeneously distributed over the entire surface of the sheet steel substrate S (FIG. 3A, left) or the coated sheet packaging product (FIG. 3A, right). This surface structure of conventional sheet packaging products leads to a variety of problems:

The sharp tips Sp can easily break off or be flattened when the sheet packaging product is subjected to mechanical stress, for example during transport or during forming into packaging. When the points Sp are broken off or flattened, the coating B is damaged or completely removed in places. This results in free, uncoated areas where the corrosion-susceptible steel sheet substrate S is exposed to the environmental influences and the filling materials of packaging made from the sheet packaging product and can thus corrode. Furthermore, this causes abrasion of the coating material, which is harmful during further processing of the sheet packaging products.

Furthermore, dirt particles and residues of oils and greases can accumulate in the pocket-shaped valleys Ta of the surface structure of conventional sheet packaging products, which can no longer be completely removed even when the coating surface of the sheet packaging products is cleaned, due to unevenly shaped valleys with undercuts. In particular, grease, cleaning agents, rolling oils or other residues from the manufacturing process of the packaging sheet product can accumulate in the deep and/or geometrically undefined valleys, which can make cleaning of the surface of the packaging sheet product more difficult and negatively affect the coating quality, such as the porosity of the tin coating in tinplate. Contamination of the surface and a formation of condensate deposited in the deep valleys also have a negative effect on corrosion resistance.

FIG. 4A shows an example of an image of a surface structure of a conventional tinplate according to the state of the art with a tin coating of 2.8 g/m² generated with the confocal topography measuring device μSurf mobile from NanoFocus AG. A 20× objective with a resolution of approx. 1.56 μm was used for the measurement.

Prior to the electrolytic application of the tin coating, the surface of the steel sheet substrate of this tinplate was first dressed in a first stand of the re-rolling mill using a work roll with a blasted surface and then in a second stand using a work roll with a ground roll surface. Dressing has given the surface of the conventional tinplate a statistically uncorrelated structure and thus an inhomogeneous surface topography, as can be seen from the associated height profile of FIG. 4A and from the 3D representation of the surface structure, the associated roughness profile and the autocorrelation function of FIG. 5A. The surface structure of the conventional tinplate shows in particular a pronounced structure of grooves extending in the rolling direction (longitudinal direction of the strip-shaped tinplate). Dirt particles and residues of rolling oils can become lodged in the grooves, which cannot be removed by ordinary cleaning steps. Furthermore, as can be seen in particular from the 2D height profile of FIGS. 4A and 5A and the associated roughness profile of FIG. 5A, the surface structure has pronounced peaks at which damage to the coating can occur under mechanical stress.

These problems of the prior art can be eliminated with the packaging sheet products according to the invention. Due to the deterministic and homogeneous surface structure of the sheet packaging products according to the invention, they are free of sharp Sp peaks with radii of curvature greater than 0.2 mm, at which damage to the coating and increased abrasion of the coating material could occur, resulting in increased susceptibility of the sheet packaging product to corrosion. Thus, both the susceptibility to corrosion and the adverse effects of abrasion can be avoided. Furthermore, the surfaces of the sheet packaging products according to the invention are also free of deep and/or geometrically undefined valleys in which dirt particles and residues, such as residual greases and rolling oils, could accumulate. In the case of the sheet packaging products according to the invention, this facilitates cleaning of the surface and thus improves corrosion resistance, because both before and after coating of the substrate S the surface of the uncoated or coated steel sheet can be largely completely freed from oil residues, dirt and deposits.

FIGS. 4B to 4G and 5B to 5G show examples of packaging sheet products with specific surface structures according to the invention. In FIGS. 5A to 5G, the parameters of the roughness profile are listed below the roughness profile, with the abbreviations used in the table of FIGS. 5A to 5G representing the following parameters:
Ra: Mean roughness value or arithmetic mean roughness (arithmetic mean value of the amounts of all profile values of the roughness profile).
Rq: root mean square of all profile values of the roughness profile
Rsk: is a measure of the asymmetry of the amplitude density curve

FIG. 4D shows an exemplary top view of a hexagonal surface structure with cylindrical elevations arranged in a hexagonal structure, each elevation E being cylindrical with an at least substantially flat or convex top surface (as shown in the surface profile of FIG. 5D). The cylindrical elevations have an average height h and an average diameter (FWHM ø) at half height and are spaced apart (on average) by a distance d.

The average height h of elevations is generally (irrespective of the geometric shape) preferably in the range from 0.1 to 8 μm, in particular between 0.5 and 4.0 μm. The diameter ø preferably has average values in the range of at least 10 μm and preferably from 60 to 250 μm and in particular between 30 and 80 μm. The distance d between adjacent elevations can be, for example, between 30 and 300 μm and in particular in the range of 60 to 250 μm.

The hexagonal basic structure with a plurality of elevations E shown in FIG. 4D can be arranged uniformly over the entire surface of a sheet packaging product according to the invention, resulting in a uniform, deterministic surface structure with hexagonal arrangements of elevations E.

The proportion Mrl of the plateau area of the elevations to the total area of the surface of the sheet packaging product (which can be referred to as the “load-bearing proportion”) is preferably between 5% and 50%. The number of elevations E with radii of curvature greater than 0.2 mm is preferably less than 50 per cm² and is in particular less than 20 per cm².

Further examples of such surface structures with a hexagonal structure of elevations E are shown in FIGS. 5E and 5G, each showing the surface of embodiments of a sheet packaging product according to the invention in a plan view with an associated roughness profile (height profile) and the resulting autocorrelation.

The embodiments of sheet packaging products according to the invention shown in FIGS. 5D, 5F and 5G are particularly suitable for increasing the corrosion resistance of the sheet packaging products due to the selected surface structure with a hexagonal arrangement of protrusions E. This results in particular from the fact that the deterministic surface structure of these examples has no sharp peaks and no deep or geometrically undefined valleys, but instead has a uniform arrangement of elevations with an at least substantially planar plateau on the upper side of the elevations, and with substantially planar valleys between the elevations E. The elevations E also withstand strong mechanical stresses due to the plateau-shaped design of the upper side, whereby abrasion and damage to the coating B can be avoided. Furthermore, no dirt or residues can settle in the valleys formed between adjacent elevations. To increase corrosion resistance, it is advantageous if the average distance between adjacent structural elements (“peak to peak distance”) is between 60 and 250 μm.

One parameter for the quantitative description of the corrosion properties of tinplate is the so-called IET value, which is measured in the standardized “Iron Exposure Test” and describes the tin porosity of the tin coating. Under constant conditions of the manufacturing process, such as pretreatment (cleaning), total tin coating and constant process parameters, the tin porosity (IET value) essentially depends on the surface roughness (arithmetic mean roughness Ra) and the tin coating (in g/m²).

In order to take into account the (quadratic) dependence of the tin porosity (IET value) on the tin coating Sn (tin weight in g/m²) in tinplate, it is useful to multiply the IET value measured on a tinplate sample (in mA/cm²) by the square of the tin coating Sn (in g/m²). FIG. 6 shows the product of the measured IET value and the tin coating squared (Sn²) for various tinplate samples, including conventional tinplate and tinplate according to the invention, and plots it against the mean roughness Ra of the samples. From the graph in FIG. 6, it can be calculated that the current density measured in the Iron Exposure Test (IET) is j_{IET}=I/A (electric current per area in mA/cm²) for the samples according to the invention is at most 1.4 times the arithmetic mean roughness Ra (in μm) plus a constant of 0.5 divided by the tin coating Sn (weight coating of tin, m/A, mass per area in g/m²) squared:

$${j}_{IET} ( in \frac{mA}{{cm}^{2}} \leq ( 1 , 4 \cdot {R}_{a} ( in μm ) + 0 , 5 / {( Sn )}^{2} .$$

The examples 1, 2 and 3 lying below the straight line (y=1.4 x+0.5) in the diagram of FIG. 6 fulfill this condition. Examples 1, 2 and 3 of FIG. 6 are specimens with a surface structure according to FIGS. 5D, 5F and 5G.

Through the IET value, a positive influence of the deterministic surface structures of the tinplate samples according to the invention on their corrosion resistance of the tinplates can be quantitatively demonstrated.

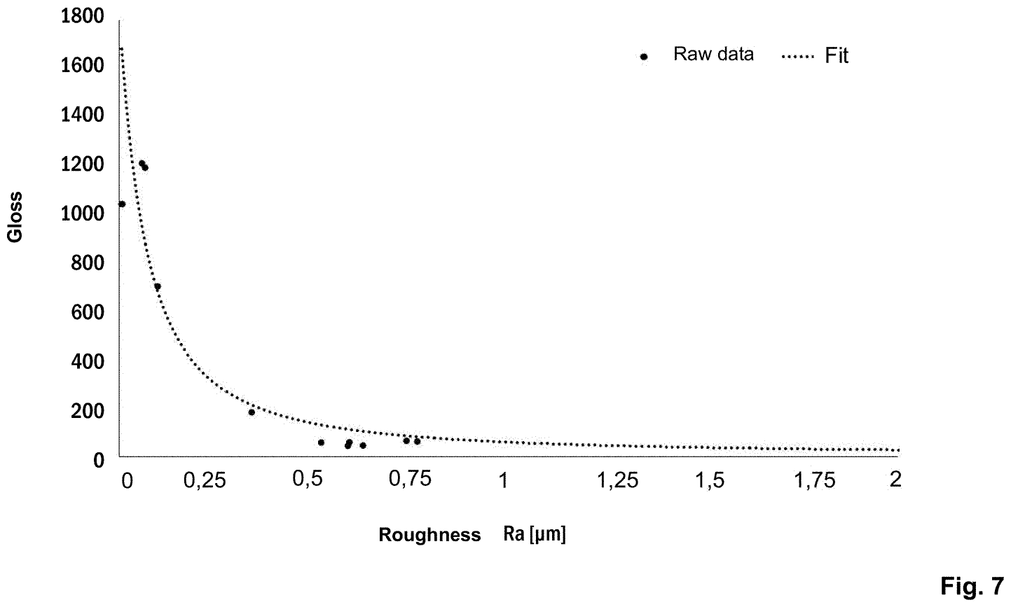

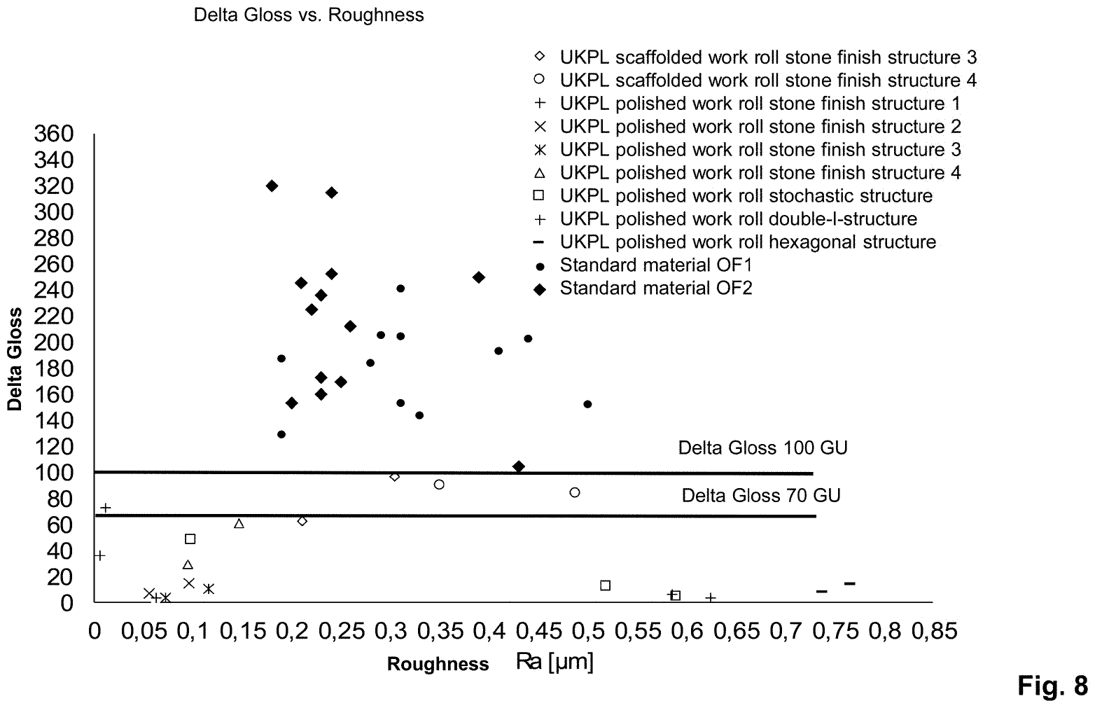

The packaging sheet products according to the invention can also be used to optimize the gloss properties. FIGS. 7 and 8 show diagrams showing the dependence of the gloss values measured on packaging sheets according to the invention (tinplate with a weight coating of 2.8 g/m²) and the isotropy of the gloss values (measured as delta gloss values (Δgloss), which represent the difference in gloss values in the rolling direction and perpendicular to it) on the surface roughness (arithmetic surface roughness Ra). As shown in FIG. 7, the gloss value (in gloss units GE) decreases (inversely proportional) with increasing roughness (Ra). With roughness Ra in the range of less than 0.4 μm, gloss values of more than 200 and, with Ra≤0.1 μm, up to approx. 1400 gloss units (GE) can be achieved with the packaging sheets according to the invention.

With a surface roughness of, for example, Ra=0.1 μm, gloss values of more than 670 can be achieved, and with surface roughnesses of Ra≤0.05 μm, gloss values of more than 1000 can be achieved.

FIG. 8 shows that homogeneous gloss properties with delta gloss values of Δgloss<100 can be achieved with the packaging sheets according to the invention, whereas conventional packaging sheets (designated “standard material” in FIG. 8) with otherwise identical coating parameters (in particular the same coating material with the same weight layer, the same process parameters in the electrolytic coating process and the same pretreatment) exhibit substantially more inhomogeneous gloss values with Δgloss>100. Preferably, the Δgloss value for the packaging sheet products according to the invention is 70 gloss units (GU) or less.

For the same surface roughness, the ΔGloss value of the packaging sheets according to the invention with deterministic surface structure is at least a factor of 4 smaller than that of the conventional packaging sheets with a statistically uncorrelated surface structure. This improvement in the homogeneity of the gloss can be explained by the uniform surface structures of the packaging sheets according to the invention with the same height or depth of the surface structures (elevations or depressions) both longitudinally and transversely to the rolling direction (longitudinal direction of the strip).

Furthermore, it can be seen from the diagram of FIG. 8 that the “double I structures” with a surface structure according to FIGS. 4B and 4E show the best results in terms of the Δgloss value with respect to isotropic and homogeneous gloss effects, respectively.

TABLE 1

| | | Topography left |
|---|---|---|
| FIG. | Roll arrangement Re-rolling mill | and right image |
| 4B | Surface according to the invention, | Left: Topography |
| | designation: double I structure | work roll |
| | Rolling Re-rolling mill: | Right: Topography |
| | Stand 1: 2 work rolls with blasted surface | sheet without coating |
| | Stand 2: 2 work rolls with UKPL structure | |
| 4C | Surface according to the invention, | Left: Topography |
| | designation: stone finish structure | work roll |
| | Rolling Re-rolling mill: | Right: Topography |
| | Stand 1: 2 work rolls with blasted surface | sheet without coating |
| | Stand 2: 2 work rolls with UKPL structure | |
| 4D | Surface according to the invention, | Left: Topography |
| | designation: hexagonal structure | work roll |
| | Rolling Re-rolling mill: | Right: Topography |
| | Stand 1: 2 work rolls with blasted surface | sheet without coating |
| | Stand 2: 2 work rolls with UKPL structure | |
| 4E | Surface according to the invention, | Left: Topography |
| | designation: double I structure | work roll |
| | Rolling Re-rolling mill: | Right: Topography |
| | Stand 1: 2 work rolls with UKPL structure | sheet with coating |
| | Framework 2: 2 work rolls with polished | |
| | surface structure | |
| 4F | Surface according to the invention, | Left: Topography |
| | designation: stone finish structure | work roll |
| | Rolling Re-rolling mill: | Right: Topography |
| | Stand 1: 2 work rolls with UKPL structure | sheet with coating |
| | Framework 2: 2 work rolls with polished | |
| | surface structure | |
| 4G | Surface according to the invention, | Left: Topography |
| | designation: hexagonal structure | work roll |
| | Rolling Re-rolling mill: | Right: Topography |
| | Stand 1: 2 work rolls with UKPL structure | sheet with coating |
| | Framework 2: 2 work rolls with polished | |
| | surface structure | |

1-37. (canceled)

38. A sheet metal packaging product consisting of a steel sheet substrate with a thickness in the range from 0.1 mm to 0.6 mm and a coating comprising at least one of tin, chromium and chromium oxide, the coating being deposited electrolytically on at least one side of the steel sheet substrate, wherein the coating comprises at least one of a tin layer with a coating weight in the range from 1 to 15 g/m² tin and a chromium layer comprising at least one of metal chromium and chromium oxide with a total coating weight of chromium in the chromium layer in the range from 5 to 200 mg/m², wherein at least one surface of the sheet packaging product provided with the coating has, in at least one direction, a surface profile with periodically recurring structural elements and an autocorrelation function, resulting from the surface profile, is comprising an absolute maximum with a given maximum height and a plurality of secondary maxima with a given height, which is at least 20% of the maximum height of the absolute maximum.

39. The sheet packaging product of claim 38, wherein the height of the secondary maxima of the autocorrelation function along a preferred direction on the sheet steel substrate is at least 40% of the maximum height of the absolute maximum.

40. The sheet packaging product according to claim 38, wherein the coating is a non-fused tin coating and wherein the height of the secondary maxima of the autocorrelation function along a preferred direction of the tin-coated steel substrate is at least 30% of the maximum height of the absolute maximum.

41. The sheet packaging product according to claim 38, wherein the sheet packaging product has a surface roughness in the range from 0.01 μm to 2.0 μm.

42. The sheet packaging product according to claim 38, wherein the topographic shape of the periodically recurring structural elements is convex or plateau-shaped and the periodically recurring structural elements have a full width at half maximum of at least 10 μm.

43. The sheet packaging product according to claim 38, wherein the coating is a tin coating with a predetermined coating weight (Sn) and in that the tin coating has a current density in the Iron Exposure Test (IET) of j_{IET}=I/A (electric current per area) in mA/cm² which is at most 1.4 times the arithmetic mean roughness (Ra) in μm of the coated substrate plus a constant of 0.5 divided by the coating weight (Sn) in g/m² squared:
$${j}_{IET} ( in \frac{mA}{{cm}^{2}} \leq ( 1.4 \cdot {R}_{a} ( in μm ) + 0.5 / {( Sn )}^{2} .$$

44. The sheet packaging product according to claim 38, wherein the coating is a tin coating with a predetermined coating weight (Sn) of tin (m/A, mass per area in g/m²) and that the current density measured in the Iron Exposure Test (IET) is j_{IET}=I/A (electric current per area) in mA/cm² multiplied by the square of the coating weight (Sn) of the tin is less than 1.9 (mA/cm²)·(g/m²)² for an arithmetic mean roughness (Ra) of Ra≤1.0 μm and less than 3.3 (mA/cm²)·(g/m²)² for an arithmetic mean roughness (Ra) of 1.0 μm<Ra≤2.0 μm.

45. The sheet packaging product according to claim 38, wherein the surface structure has a regularly arranged pattern with elevations and depressions, the elevations projecting by an average height of 0.5 to 3.0 μm above an average level averaged over the entire surface of the sheet packaging product, and the depressions have an average depth of 0.5 to 3.0 μm, relative to the average level.

46. The sheet packaging product according to claim 38, wherein the periodically recurring arrangement are comprising at least one of convex and concave structural elements, web-shaped elements which are trapezoidal in a cross section, plate-shaped elements, groove-shaped depressions, plateau-shaped elevations, convex protrusions protruding above the surface of the sheet steel substrate, rectangular elements, strip-shaped element, bar-shaped element, cylindrical elements, leaf-shaped elements, crescent-shaped elements, strips extending in a longitudinal direction, ridge-shaped protrusions.

47. The sheet packaging product according to claim 38, wherein the surface of the sheet packaging product has a gloss value of more than 50 gloss units and a surface roughness of less than 0.5 μm and more than 0.1 μm.

48. The sheet packaging product according to claim 38, wherein the surface of the sheet packaging product has a direction-dependent gloss value, wherein the difference in gloss value in the rolling direction and a transverse direction perpendicular thereto is less than 100 gloss units.

49. The sheet packaging product according to claim 38, wherein the sheet steel substrate has the following composition in terms of weight fractions:
C: 0.01-0.1%,
Si: <0.03%,
Mn: 0.1-0.6%,
P: <0.03%,
S: 0.001-0.03%,
Al: 0.002-0.1%,
N: 0.001-0.12%,
optional Cr: <0.1%,
optional Ni: <0.1%,
optional Cu: <0.1%, optional Ti: <0.09%,
optional B: <0.005%,
optional Nb: <0.02%,
optional Mo: <0.02%,
optional Sn: <0.03%,
rest iron and unavoidable impurities.

50. A method of manufacturing a sheet packaging product having a textured surface, the method comprising:
providing a primary cold-rolled steel sheet substrate with a thickness in the range of 0.1 mm to 0.6 mm;
recrystallizing annealing of the primary cold-rolled steel sheet substrate;
re-rolling or skin-passing of the recrystallization-annealed steel sheet substrate in a two-stand re-rolling mill, wherein a first stand of the re-rolling mill has at least one working roll with an unstructured roll surface, and a second stand of the re-rolling mill has at least one working roll with a surface-structured roll surface;
electrolytic coating of the re-rolled or skin-passed steel sheet substrate on at least one side with a coating comprising at least one of tin, chromium and chromium oxide, the coating comprising at least one of a tin layer with a coating weight in the range from 1 to 15 g/m² tin and a chromium layer comprising at least one of metallic chromium and chromium oxide with a total coating weight of chromium in the chromium layer in the range from 5 to 200 mg/m²;
wherein the sheet packaging product has a surface profile with periodically recurring structural elements in at least one direction after coating of the steel sheet with the coating, wherein the surface profile has an autocorrelation function which has an absolute maximum with a maximum height and a plurality of secondary maxima with a height, which is at least 20% of the maximum height of the absolute maximum.

51. The method according to claim 50, wherein the surface of the at least one working roll of the second stand has been structured by a pulsed laserser.

52. The method according to claim 50, wherein the coating is a tin coating and, after the electrodeposition of the tin coating, the surface of the coating is fuzed by heating to temperatures above the melting point of tin or the surface of the coating is provided with a chromium passivation layer, comprising at least one of chromium and chromium oxide or a chromium-free passivation layer.

53. The method according to claim 50, wherein a thickness reduction of the cold-rolled and electrolytically coated steel sheet substrate to a final thickness in the range of 0.1 mm to 0.5 mm is effected during re-rolling or skin-passing, wherein during re-rolling the relative thickness reduction is in the range of more than 5% and up to 50% and during skin-passing the relative thickness reduction is in the range of 0% to 5%.

54. A steel sheet having a thickness in the range from 0.05 mm to 0.6 mm, wherein the surface of the steel sheet has in at least one direction a surface profile with periodically recurring structural elements, the surface profile having an autocorrelation function with an absolute maximum having a given maximum height and a plurality of secondary maxima having a height, which is at least 40% of the maximum height of the absolute maximum.
